(19) United States
(12) Patent Application Publication
(10) Pub. No.: US 2007/0190298 A1
(43) Pub. Date: Aug. 16, 2007

(54) Security features, their use and processes for making them

(75) Inventors: Mark J. Hampden-Smith, Albuquerque, NM (US); Richard Anthony Einhorn, Albuquerque, NM (US); Scott Thomas Haubrich, Albuquerque, NM (US); Ned Jay Hardman, Albuquerque, NM (US); Jainisha R. Shah, Albuquerque, NM (US); Rimple Bhatia, Placitas, NM (US); Ralph E. Kornbrekke, Albuquerque, NM (US)

Correspondence Address: Jaimes Sher, Esq.;Cabot Corporation, 5401 Venice Avenue NE, Albuquerque, NM, 87113, US

(73) Assignee: Cabot Corporation, Boston, MA (US)

(21) Appl. No.: 11/331,233

(22) Filed: Jan. 13, 2006

Related U.S. Application Data
(60) Provisional application No. 60/643,577, filed on Jan. 14, 2005.

(51) Int. Cl. B32B 3/00

(52) U.S. Cl. 428/204

(57) ABSTRACT

This invention is directed to security features that are formed, created, printed from inks comprising metallic particles and/or metallic nanoparticles. Preferably, the security feature is a reflective security features that comprises metallic nanoparticles where the reflective security features are formed by a direct-writing process, e.g., an ink jet printing process, using an ink comprising metallic nanoparticles. The invention is also directed to the use of these security features in many applications and to processes for making them.

### CROSS-REFERENCE TO RELATED APPLICATION

This patent application claims priority to U.S. Provisional Patent Application Ser. No. 60/643,577, filed Jan. 14, 2005, the entirety of which is incorporated herein by reference.

### FIELD OF THE INVENTION

The present invention relates to security features, their use, and to processes for making security features. In particular, the invention relates to security features that are reflective, and preferably formed, at least in part, from metallic particles, preferably metallic nanoparticles. The invention also relates to processes of making these security features, in particular a process for printing a reflective security feature utilizing a metallic particle and/or metallic nanoparticle containing ink.

### BACKGROUND OF THE INVENTION

Recent advances in color copying and printing have put increasing importance on developing new methods to prevent forgery of security documents such as banknotes. While there have been many techniques developed, one area of increasing interest is in developing security features that cannot be readily reproduced, particularly by a color copier or printer.

One approach that has been taken is to formulate an ink for creating a printed image that is visually distinct from its reproduction. For example, U.S. Pat. Nos. 5,059,245, 5,569,535, and 4,434,010, the entireties of which are incorporated herein by reference, describe the use of stacked thin film platelets or flakes. Images produced with these pigments exhibit angular metamerism—that is, their color changes depending on the angle in which they are viewed. These pigments have been incorporated into security inks used, for example, in paper currency. These pigments have also been incorporated into plastics applications (see, for example, PCT Publication WO 00/24580, published May 4, 2000). Additional inks and security features are described in U.S. Pat. Nos. 4,705,356; 4,779,898; 5,278,590; 5,766,738; and 6,114,018, the entireties of which are incorporated herein by reference.

U.S. Pat. No. 6,013,307, the entirety of which is incorporated herein by reference, discloses a printing ink that contains a single dye or mixture of at least two dyes that is formulated in order to create the greatest possible metamerism between the formulated ink and a reference ink on the basis of two defined types of illumination. The original image is described as having visually clearly identifiable differences compared to its copy.

Another approach used to produce security documents has been to produce a “covert” image that contains a material which cannot be seen by the naked eye but which can be made visible under specific conditions. For example, U.S. Pat. Nos. 5,324,567, 5,718,754, and 5,853,464 disclose the use of Raman active compounds. U.S. Pat. Nos. 5,944,881 and 5,980,593 describe fluorescent materials that can be used in an ink. Also, U.S. Pat. No. 4,504,084 discloses a document containing an information marking comprised of a first color that is at least partially opaque or visible in infrared light and a second color, which conceals the first color in the visible spectrum, but is invisible to infrared light.

Inks that change upon chemical exposure have also been used for security documents. For example, U.S. Pat. Nos. 5,720,801, 5,498,283, and 5,304,587 disclose ink compositions that are invisible when printed, and develop a color upon exposure to bleach.

While these efforts afford printed images that are difficult to reproduce, advances in color copiers and color printers continue to be made. Therefore, a need remains to provide a method of producing images, particularly for security documents, which cannot be easily reproduced, and which are visually distinct from their reproductions.

Additionally, the need exists for providing the ability to create security features that display variable information, e.g., information that is individualized for a specific product unit, such as a serial number, which variable information cannot be easily or readily duplicated or copied. The need also exists for providing the ability to create security features displaying variable information and having high resolution at commercially acceptable rates.

### SUMMARY OF THE INVENTION

In one embodiment, the present invention is directed to a reflective security feature comprising metallic particles.

In another embodiment, the invention is to a digitally-printed reflective security feature, which optionally comprises metallic particles.

The metallic particles may have an average particle size of less than about 5 μm, less than about 1 μm, less than about 500 nm, or less than about 100 nm. The metallic particles optionally have an average particle size of from about 50 nm to about 100 mm. The security feature optionally comprises metallic nanoparticles. At least a portion of the reflective security feature preferably displays variable information. Also, the reflective security feature may be luminescent.

In one aspect, the reflective security feature at least partially overlaps an image on a substrate surface. At least a portion of the image optionally is viewable through the reflective security feature when viewed at a first angle relative to the substrate surface, but at least a portion of the image is at least partially obscured when viewed from a second angle relative to the substrate surface.

The reflective security feature may be made by a process which comprises ink-jet printing an ink comprising the metallic particles onto a substrate.

Preferably, the reflective security feature exhibits an optical effect that is difficult to reproduce. For example, the reflective security feature optionally is disposed on a substrate comprising a sheet of transparent material and a reflective layer, the transparent material having a transparent surface, and the reflective security feature being disposed on the transparent surface. In this aspect, the reflective security feature preferably exhibits an optical interference pattern.

The metallic particles optionally comprise a metal selected from the group consisting of silver, gold, zinc, tin, copper, platinum and palladium or a combination thereof. The average distance between adjacent metallic particles optionally is less than about 700 nm. For example, a majority of the metallic particles may be necked with at least one adjacent nanoparticle.

In one embodiment, the reflective security feature comprises a reflective layer that is at least partially semitransparent. In one embodiment, the reflective layer comprises a non-continuous reflective layer, the non-continuous reflective layer comprising the metallic particles. The reflective layer may comprise a plurality of microimages, at least one of the microimages optionally comprising variable information. The plurality of microimages preferably has an average largest dimension of less than about 0.5 mm. In another embodiment, the reflective layer comprises a continuous reflective layer, the continuous reflective layer comprising the metallic particles. The continuous reflective layer may be translucent or opaque. For example, the continuous reflective layer optionally at least partially overlaps an image on a substrate surface, the image having a longitudinally varying topography. In this embodiment, the continuous reflective layer preferably presents a translation of the longitudinally varying topography of the overlapped image.

In another embodiment, the invention is to a security feature, comprising (a) a substrate having a surface, the surface comprising an image; and (b) a reflective layer comprising metallic particles disposed on at least a portion of the surface and at least partially overlapping the image. At least a portion of the image preferably is viewable through the reflective layer when viewed at a first angle relative to the surface, but at least a portion of the image may be at least partially obscured when viewed from a second angle relative to the surface. The second angle preferably is about 180° minus the angle of incident light, relative to the surface. The reflective layer optionally comprises a plurality of reflective images. The image optionally is formed from a printing process selected from the group consisting of direct write printing, intaglio printing, gravure printing, lithographic printing and flexographic printing processes. In another aspect, the image is selected from the group consisting of a hologram, a black and white image, a color image, a watermark, a UV fluorescent image, text and a serial number.

In another embodiment, the invention is to a process for forming a reflective security feature, the process comprising the steps of: (a) providing an ink comprising metallic particles; and (b) direct write printing the ink to form the reflective security feature. At least a portion of the reflective security feature optionally displays variable information, which optionally comprises covert information and/or overt information. Ideally, the reflective security feature is formed at a rate greater than about 15 m/s. Step (b) preferably occurs continuously at a substantially constant temperature. In one embodiment, step (b) comprises ink jet printing the ink from an ink reservoir, through a print head, and onto a substrate, wherein the temperature of the ink reservoir or print head is greater than about 30° C. Optionally, the process further comprises the step of: (c) applying ultraviolet or infrared radiation to the printed ink. Optionally, the ink comprises a non-UV-curable vehicle, and the process further comprises the step of: (c) applying ultraviolet radiation to the printed ink. The reflective security feature optionally is printed on a substrate comprising a sheet of transparent material and a reflective layer, the transparent material having a transparent surface, and the reflective security feature being printed on the transparent surface, preferably causing the security feature to exhibit an optical interference pattern. In a particularly preferred embodiment, step (b) comprises direct write printing the ink onto a substrate surface having an image to form the reflective security feature. In this aspect, the image preferably is viewable through at least a portion of the image but may be at least partially obscured when viewed from a second angle relative to the surface. The image may be formed from a printing process selected from the group consisting of direct write printing, intaglio printing, gravure printing, lithographic printing and flexographic printing processes. In another embodiment, the image is selected from the group consisting of a hologram, a black and white image, a color image, a watermark, a UV fluorescent image, text and a serial number.

In another embodiment, the invention is to a direct write printing process for printing a security feature utilizing a direct write printer having a direct write head, the direct write head capable of generating and depositing droplets of an ink on a substrate, the ink comprising metallic particles, the process comprising the steps of operating the direct write head at greater than 5000 s⁻¹ such that each drop of ink generated comprises about 5 picoliters to about 100 picoliters of the ink, and wherein the substrate is moving at a rate of greater than 1 m/s. The process optionally further comprises the step of heating the ink and/or the direct write head. Specifically, the temperature of the ink or the direct write head optionally is maintained at a temperature of from about 30° C. to about 100° C. Preferably, the operating occurs continuously at a substantially constant temperature. The direct write head preferably has one or more orifices having a diameter of not greater than about 100 μm. The security feature formed preferably has a size less than about 200 μm, and optionally comprises variable information, optionally covert information and/or overt information. The security feature preferably is formed at a rate greater than about 15 m/s. The process optionally further comprises the step of applying ultraviolet or infrared radiation to the deposited droplets. In one aspect, the ink comprises a non-UV-curable vehicle, and the process further comprises the step of applying ultraviolet radiation to the deposited droplets.

In another embodiment, the invention is to a process for forming reflective security features, the process comprising the steps of: (a) providing an ink comprising metallic particles; and (b) printing the ink onto a substrate to form the reflective security features at a rate greater than 1 m/s (e.g., greater than about 5 m/s, 10 m/s, 15 m/s or 20 m/s), based on the rate of the substrate. Step (b) optionally comprises direct write printing (e.g., ink jet printing or digitally printing) the ink to form the reflective security feature. Preferably, the security features have a resolution, at least in part, greater than about 200 dpi (e.g., grater than about 300 dpi or greater than about 400 dpi) in the x and/or y directions.

In another embodiment, the invention is to a security feature comprising metallic particles and exhibiting a conductivity authentication feature. For example, the metallic particles preferably comprise a bulk metal and at least a portion of the security feature may have a resistivity not higher than about 30 times or not higher than about 20 times the resistivity of the bulk metal. The security feature preferably is also reflective and/or includes a magnetic property. In one aspect, the security feature is substantially non-conductive but comprises a conductive portion. For example, the conductive portion may have a resistivity that is less than about 30 times or less than about 20 times the resistivity of the bulk metal, while the security feature may have a resistivity that is at least 30 times or at least 50 times the resistivity of the bulk metal.

In another embodiment, the invention is to a UV curable security feature comprising metallic particles and free of a UV curable organic composition. The metallic particles preferably have an average particle size of less than about 5 μm or less than about 1 μm. The UV curable security feature optionally comprises metallic nanoparticles. The UV curable organic composition optionally is a UV curable vehicle or a UV curable monomer or polymer. Ideally, the UV curable security feature is curable to form a sintered network of the metallic nanoparticles.

In another embodiment, the invention is to a substantially non-conductive UV curable security feature comprising conductive portions or components, wherein the security feature is free of a UV curable composition.

In another embodiment, the invention is to a security feature, comprising: (a) a first layer comprising first metallic particles, the first metallic particles comprising a first metal oxide; and (b) a second layer disposed at least in part on the first layer, the second layer comprising second metallic particles comprising a second metal oxide. Preferably, The security feature further comprises: (c) a third layer disposed at least in part on the second layer, the third layer comprising third metallic particles comprising the first metal oxide. Optionally, the first metal oxide is selected from the group consisting of silica, titania and mica, wherein the second metal oxide is selected from the group consisting of silica, titania and mica, and wherein the first metal oxide is different from the second metal oxide. In a preferred embodiment, the first metal oxide comprises titania and the second metal oxide comprises mica. This security feature preferably exhibits a color shift as it is tilted so as to provide an optical effect that is very difficult for a would-be counterfeiter to reproduces.

In other embodiments, the invention is to banknotes, brand authentication tags, articles or manufacture, tax stamps, alcohol bottles and tobacco products comprising one or more of the security features of the present invention.

### BRIEF DESCRIPTION OF THE DRAWINGS

The present invention will be better understood in view of the non-limiting figures, wherein:

FIGS. 1A-E present several examples of patterns that may be employed to form a semitransparent reflective feature having openings or gaps therein;

FIGS. 2A-C present an example of a security device, which demonstrates the photo-obscuring effect of one aspect of the present invention;

FIG. 3 presents a cross-section of a security feature according to one embodiment of the invention; and

FIGS. 4A-B present a cross-section of a security feature according to another embodiment of the invention.

### DETAILED DESCRIPTION OF THE INVENTION

Introduction

Security features in various applications such as branded products, for example, perfumes, drugs, tobacco, alcohol products and the like, and security documents, for example, passports, bonds, tickets, tax stamps, banknotes, and the like, have become a very important industry. Counterfeiters are becoming more sophisticated, and technology developments such as advanced color copiers are making it easier for these individuals to deprive businesses and consumers of billions of dollars per year.

There are many security devices already in use today. Security features in general have been produced from a variety of processes and from many types of inks. Typically, these processes have included screen-printing, off set printing, and intaglio printing using conventional pastes or paste inks. Until the development of the inventive processes for producing unique materials such as the inventive metallic particles, preferably metallic nanoparticles, however, the security features of the present invention have not been possible. The inks, preferably the digital inks comprising the metallic particles, preferably nanoparticles, used to form the security features of the present invention not only improve upon the above-described processes, but provide for the ability to direct-write print, digitally print, or ink jet print security features, preferably reflective security features. Additionally, direct-write printing, in particular ink jet printing, provides the ability to form security features that cannot be formed by conventional processes. For example, the invention is also directed to security features comprising variable information, e.g., through serialization or individualization. Without direct-write printing this would be tremendously inefficient and expensive, if not impossible. In addition, the inks of the invention work surprisingly well in commercial applications where high-speed printing is required.

Metallic Particles

The invention, in several embodiments, is directed to security features, preferably reflective security features, comprising metallic particles, preferably metallic nanoparticles, and to processes for forming such security features from inks, preferably digital inks, comprising these metallic particles and/or metallic nanoparticles. As used herein, the term “metallic particles” means particles comprising a metal or metallic characteristic and having an average particle size of less than about 10 μm. Preferably, the metallic particles have an average particle size of less than about 7 μm, preferably less than about 5 μm, more preferably less than about 3 μm, and even more preferably less than about 2 μm. The term “metallic nanoparticles” means particles comprising a metal or metallic characteristic and having an average particle size of less than about 1 μm. One skilled in the art would appreciate that there are many techniques for determining the average particle size of a population of particles, scanning electron microscopy (SEM) being a particularly preferred technique. Other methods for determining the average particle size of micron-sized particles (e.g., from about 1 μm to about 10 μm) is by single particle light obscuration techniques (e.g., with an AccuSizer™ particle size analyzer). The average particle size of smaller particles (e.g., smaller than about 1 μm) is also determinable using quasi-elastic light scattering (QELS) techniques (e.g., using a Malvern™ ZetaSizer™). By “comprising a metal” it is meant all or a portion of the particles include, in whole or in part, a metal (e.g., an elemental metal (zero oxidation state) or a mixture or alloy of metals) or a metal-containing compound (e.g., a metal oxide or metal nitride). Thus, in a preferred embodiment, the metallic particles and/or metallic nanoparticles comprise a component selected from the group consisting of a metal, a metal alloy, and a metal-containing compound (e.g., a metal oxide). Additionally or alternatively, the metallic particles and/or metallic nanoparticles may comprise a component having a metallic characteristic. The term “metallic characteristic” means a reflective or lustrous optical property similar to a metal. For example, a component may exhibit a metallic characteristic by virtue of it having a small electronic band gap.

As indicated above, the metallic particles and/or metallic nanoparticles of the invention preferably have an average particle size of less than about 1 μm. In another embodiment, the metallic particles and/or metallic nanoparticles have an average particle size of less than about 500 nm, more preferably less than about 250 nm, even more preferably less than about 100 nm, and most preferably less than about 80 nm. The metallic particles and/or metallic nanoparticles optionally have an average particle size greater than about 20 nm, greater than about 25 nm, greater than about 30 nm, greater than about 40 nm, greater than about 50 nm, greater than about 100 nm, greater than about 250 nm or greater than about 500 nm. In terms of ranges, the metallic particles and/or metallic nanoparticles of the invention optionally have an average particle size in the range of from about 20 nm to about 5 μm, preferably from about 25 nm to about 3 μm, more preferably from about 30 nm to about 2 μm, yet more preferably from about 40 nm to about 1 μm, more preferably from about 50 nm to about 500 nm, more preferably from about 50 nm to about 100 nm, and most preferably from about 50 nm to about 80 nm. The metallic particles and/or metallic nanoparticles may have a unimodal or multi-modal (e.g., bimodal, trimodal, etc.) particle size distribution.

In one embodiment, the metallic particles and/or metallic nanoparticles are substantially free of particles having a particle size (meaning largest dimension, e.g., diameter of a spherical particle) greater than 5 μm, e.g., greater than 4 μm, greater than 3 μm, greater than 2 μm, greater than 1 μm, greater than 500 nm, greater than 250 nm, or greater than 100 nm. For purpose of this patent specification and appended claims, “substantially free” means comprising not more than about 50%, preferably not more than about 40%, more preferably not more than about 30%, more preferably not more than about 20%, more preferably not more than about 10%, more preferably not more than about 5%, more preferably not more than about 1%, more preferably not more than about 0.5%, and most preferably not more than about 0.25%, by weight.

Non-limiting examples of metals for use in the metallic particles and/or metallic nanoparticles and security features of the present invention include transition metals as well as main group metals such as, for example, silver, gold, copper, nickel, cobalt, palladium, platinum, indium, tin, zinc, titanium, chromium, tantalum, tungsten, iron, rhodium, iridium, ruthenium, osmium, lead and mixtures thereof. Non-limiting examples of preferred metals for use in the present invention include silver, gold, zinc, tin, copper, nickel, cobalt, rhodium, palladium and platinum—silver, copper and nickel being particularly preferred. The metallic particles and/or metallic nanoparticles optionally comprise a metal selected from the group consisting of silver, gold, zinc, tin, copper, platinum and palladium or a combination thereof. Non-limiting examples of metal-containing compounds or components that exhibit metallic characteristics and that may be useful as metallic particles and/or metallic nanoparticles of the security features and inks of the present invention include metal oxides, metal nitrides (e.g., titanium nitride or tantalum nitride), metal sulphides and some semiconductors. The metal-containing compound(s) preferably have a small electronic band gap that gives rise to metallic properties or characteristics. A non-limiting list of exemplary metal oxides includes bronzes such as tungsten bronzes including hydrogen tungsten oxide, sodium tungsten oxide and lithium tungsten oxide as well as other bronzes such as phosphor bronzes. Additional tungsten oxides are described in Published U.S. Patent Application No. 2005/0271566A1, which published Dec. 8, 2005, the entirety of which is incorporated herein by reference. In one aspect, the metallic particles and/or metallic nanoparticles comprise a mineral having a metallic characteristic. A non-limiting list of exemplary minerals suitable for the metallic particles and/or metallic nanoparticles includes marcasites and pyrites. In another embodiment, the metallic particles and/or the metallic nanoparticles comprise an enamel or a glass/metal composite that provides a metallic characteristic. In one embodiment, the metallic particles and/or metallic nanoparticles comprise a pearlescent material and/or an opalescent material that provides a metallic characteristic.

The security features of the present invention (as well as the inks used to make, form, print, or create the security features of the present invention) also, in one embodiment, comprise mixtures of two or more different metallic particles and/or metallic nanoparticles, optionally with a pigment or a dye. In another embodiment, the security features of the present invention comprise metallic particles and/or metallic nanoparticles that comprise two or more metals in the form of an alloy or a mixture of metals or metal containing compounds. Non-limiting examples of alloys useful as metallic particles and/or metallic nanoparticles of the invention include Cu/Zn, Cu/Sn, Ag/Ni, Ag/Cu, Pt/Cu, Ru/Pt, Ir/Pt and Ag/Co. Optionally, the metallic particles and/or nanoparticles comprise an alloy such as bronze, tungsten bronzes or brass. Also, in an embodiment, the metallic particles and/or metallic nanoparticles have a core-shell structure made of two different metals such as, for example, a core comprising nickel and a shell comprising silver (e.g. a nickel core having a diameter of about 20 nm surrounded by an about 15 nm thick silver shell). In another embodiment, the core-shell structure may be comprised of a metal oxide core with another metal oxide coating. A non-limiting example is a nanoparticle core-shell structure comprising a mica core and a titania coating. In another embodiment, the metallic particles and/or metallic nanoparticles comprise metal-effect particles and/or pigments. One method for creating metal effect pigments is to deposit thin layers of one metal oxide or ceramic on the surface of another (e.g. TiO₂ on mica). Metal-effect pigments are further described in CENEAR Vol. 81, No. 44, pp. 25-27 (Nov. 3, 2003) (ISSN 0009-2347), the entirety of which is incorporated herein by reference.

In another embodiment, the metallic particles and/or metallic nanoparticles comprise composite particles having a first phase, which is metallic, and a second phase, which is non-metallic. In this embodiment, the second phase preferably does not substantially detract from the reflectivity or luster of the metallic first phase. Non-limiting examples for the second phase include silicates, borates, and silica. The structure of the composite particles may be such that the second phase is mixed with the first phase to form the metallic particles and/or metallic nanoparticles, the first phase is a coating over the second phase, or the second phase is a coating over the first phase. In another embodiment, the metallic particles and/or metallic nanoparticles comprise composite particles comprising a first metal phase (comprising an elemental metal or a mixture or alloy of metals) and a second phase comprising a metal-containing compound (e.g., a metal oxide such as titania or alumina). In another embodiment, the metallic particles and/or metallic nanoparticles comprise composite particles comprising a first metal phase (comprising an elemental metal or a mixture or alloy of metals) and a second phase comprising a pigment or dye. The pigment or dye preferably does not substantially detract from the reflectivity or luster of the first phase. In this aspect, the pigment or dye may change the color of the metallic particles and/or metallic nanoparticles from the native metallic color of the first phase to another color (e.g. gold). Non-limiting examples for dyes or pigments suitable for the second phase include one or more of yellow, green, blue, red, and/or orange dyes or pigments. The metallic color achieved in the composite (or non-composite) metallic particles and/or the metallic nanoparticles optionally is selected from the group consisting of silver, copper, bronze, gold, and black, as well as a metallic reflectivity or luster of any color of the visible spectrum.

Metallic particles and/or metallic nanoparticles suitable for use in the security features, preferably the reflective security features of the present invention and in the inks, preferably the digital inks, used to form these security features, preferably the reflective security features, can be produced by a number of methods. For example, the metallic particles and/or metallic nanoparticles may be formed by spray pyrolysis, as described, for example, in U.S. Provisional Patent Application No. 60/645,985, filed Jan. 21, 2005, or in an organic matrix, as described in U.S. patent application Ser. No. 11/117,701, filed Apr. 29, 2005, the entireties of which are fully incorporated herein by reference. A non-limiting example of one preferred method of making metallic particles and metallic nanoparticles, is known as the polyol process, and is disclosed in U.S. Pat. No. 4,539,041, which is fully incorporated herein by reference. A modification of the polyol process is described in, e.g., P.-Y. Silvert et al., “Preparation of colloidal silver dispersions by the polyol process” Part 1—Synthesis and characterization, J. Mater. Chem., 1996, 6(4), 573-577; Part 2—Mechanism of particle formation, J. Mater. Chem., 1997, 7(2), 293-299, both disclosures of these documents are fully incorporated by reference herein. Briefly, in the polyol process a metal compound is dissolved in, and reduced or partially reduced by a polyol such as, e.g., a glycol, at elevated temperature to afford corresponding metal particles. In the modified polyol process, the reduction is carried out in the presence of a dissolved anti-agglomeration substance, preferably a polymer, most preferably polyvinylpyrrolidone (PVP).

A particularly preferred modification of the polyol process for producing metallic particles, especially metallic nanoparticles, is described in co-pending U.S. Patent Application Ser. Nos. 60/643,577 filed Jan. 14, 2005, 60/643,629 filed Jan. 14, 2005, and 60/643,578 filed Jan. 14, 2005, and Cabot Corporation's Patent Docket numbers 2005A001.2, 2005A002.2, 2005A003.2, which are all herein fully incorporated by reference. In a preferred aspect of a modified polyol process, a dissolved metal compound (e.g., a silver compound such as silver nitrate) is combined with and reduced by a polyol (e.g., ethylene glycol, propylene glycol and the like) at an elevated temperature (e.g., at about 120° C.) and in the presence of a polymer, preferably a heteroatom-containing polymer such as PVP.

The metallic particles and/or metallic nanoparticles in the security features, preferably the reflective security features, or in the inks, preferably the digital inks, used to form these features optionally include an anti-agglomeration substance that inhibits agglomeration of the metallic particles and/or metallic nanoparticles when dispersed in an ink, preferably a metallic ink, even more preferably a digital ink, e.g., an ink jet ink. The anti-agglomeration substance may be inorganic or organic and may comprise a low molecular weight compound, preferably a low molecular weight organic compound, e.g., a compound having a molecular weight of not higher than about 500 amu, more preferably not higher than about 300 amu, and/or may comprise an oligomeric or polymeric compound, preferably organic polymeric compound, having a (weight average) molecular weight of at least about 1,000 amu, for example, at least about 3,000 amu, at least about 5,000 amu, or at least about 8,000 amu, but preferably not higher than about 500,000 amu, e.g., not higher than about 200,000 amu, or not higher than about 100,000 amu. By way of non-limiting example, the anti-agglomeration substance, preferably a polymer, and more preferably a polyvinylpyrrolidone, optionally has a weight average molecular weight in the range of from about 3,000 amu to about 60,000 amu. For example, the anti-agglomeration substance optionally has a weight average molecular weight of about 10,000 amu, about 20,000 amu, about 30,000 amu, about 40,000 amu or about 50,000 amu. Particularly preferred polymers for use as an anti-agglomeration substance in the present invention include polymers which comprise monomer units of one or more unsubstituted or substituted N-vinyllactams, preferably those having from about 4 to about 8 ring members such as, e.g., N-vinylcaprolactam, N-vinyl-2-piperidone and N-vinylpyrrolidone. These polymers include homo- and copolymers, and combinations thereof. Other non-limiting examples of polymers which are suitable for use as anti-agglomeration substance in the present invention are disclosed in, e.g., U.S. Patent Application Publication 2004/0182533 A1, which published Sep. 23, 2004, the entire disclosure of which is expressly incorporated by reference herein. In a preferred embodiment, the metallic particles and/or the metallic nanoparticles comprise a metal or metal-containing compound, or a compound having a metallic characteristic, and an anti-agglomeration agent, preferably a polymer, and most preferably a heteroatom-containing polymer.

According to a preferred aspect of the present invention, the metallic particles and/or metallic nanoparticles useful in the inks and security features of the present invention exhibit a small average particle size, preferably with a narrow particle size distribution. A narrow particle size distribution may be used in direct-write applications or digital printing because it may limit clogging of the orifice of a direct-write device, e.g., an ink jet head or cartridge, by large particles. Narrow particle size distributions also may provide the ability to form features having a high resolution and/or high packing density.

The metallic particles and/or metallic nanoparticles for use in the present invention optionally also show a high degree of uniformity in shape. The metallic particles and/or metallic nanoparticles for use in the compositions, preferably the ink compositions and/or the security features of the present invention, more preferably the digital ink compositions of the present invention, optionally are substantially one shape, e.g., optionally substantially spherical in shape. Substantially spherical metallic particles and/or metallic nanoparticles may be able to disperse more readily in a liquid suspension and impart advantageous flow characteristics, particularly for deposition in an ink, preferably an ink jet ink or a digital ink for use with an ink-jet device, direct write tool or other similar device or tool. For a given level of solids loading, a low viscosity metallic composition having substantially spherical metallic particles and/or metallic nanoparticles may have a lower viscosity than a composition having non-spherical metallic particles, such as metallic flakes. Substantially spherical metallic particles and/or metallic nanoparticles may also be less abrasive than jagged or plate-like particles, thus, likely reducing the amount of abrasion and wear on the deposition tool.

In one embodiment, at least about 70 wt. %, at least about 80 wt. %, at least about 85 wt. %, at least about 90 wt. %, at least about 95 wt. %, or at least about 99 wt. % of the metallic particles and/or metallic nanoparticles useful in the present invention, e.g., in the security features, preferably the reflective security features, and/or in the inks, preferably the digital inks used to form the security features, are substantially spherical in shape. In another embodiment, the metallic particles and/or metallic nanoparticles, are in the range of from about 70 wt. % to about 100 wt. % substantially spherical in shape, e.g., from about 80 wt. % to about 100 wt. % substantially spherical in shape or from about 90 wt. % to about 100 wt. % substantially spherical in shape. In another embodiment, the security features and/or the inks used to form the security features are substantially free of metallic particles in the form of flakes. Conversely, in other aspects, the security features and/or the inks used to form the security features comprise metallic particles and/or metallic nanoparticles in the form of flakes, rods, tubes, tetrapods, platelets, needles, discs and/or crystals, optionally in the same weight percents described above with respect to spherical particles.

Ink Formulations Used to Form Security Features

The ink or inks used to form the security features of the present invention may comprise a variety of different components. Ideally, the ink comprises metallic particles, preferably metallic nanoparticles, as fully described above. Additionally, the ink preferably comprises a vehicle capable of dispersing the metallic particles and/or metallic nanoparticles. Optionally, the ink may also include one or more additives.

The metallic particles and/or metallic nanoparticles, described above, are useful in inks, preferably ink jet inks or digital inks for printing, preferably ink-jet printing or direct write printing or digitally printing the security features, e.g., the reflective security features, and/or conductive security features of the present invention. Although highly material dependant, in various embodiments, the metallic particle and/or metallic nanoparticle loading in the inks, e.g., in the ink jet inks or digital inks, is at least about 2% by weight, e.g., at least about 5% by weight, at least about 10% by weight, at least about 15% by weight, at least about 20% by weight, or at least about 40% by weight, based on the total weight of the total ink composition. It is preferred for the total loading of metallic particles and/or metallic nanoparticles useful in the inks used to form the security features of the present invention to be not higher than about 75% by weight, e.g., not higher than about 40% by weight, not higher than about 20% by weight, not higher than about 10% by weight, or not higher than about 5% by weight, based on the total weight of the ink composition. In various embodiments, in terms of ranges, the ink comprises from about 1 wt % to about 60 wt. % metallic particles and/or metallic nanoparticles, e.g., from about 2 to about 40 wt. % metallic particles and/or metallic nanoparticles, from about 5 to about 25 wt. % metallic particles and/or metallic nanoparticles, or from about 10 to about 20 wt. % metallic particles and/or metallic nanoparticles, based on the total weight of the ink composition. In various other embodiments, the ink comprises from about 40 wt % to about 75 wt. % metallic particles and/or metallic nanoparticles, e.g., from about 40 to about 60 wt. % metallic particles, based on the total weight of the ink composition. Loadings in excess of the preferred loadings can lead to undesirably high viscosities and/or undesirable flow characteristics. Of course, the maximum loading that still affords useful results also depends on the density of the metallic particles and/or metallic nanoparticles. In other words, for example, the higher the density of the metal of the metallic particles and/or metallic nanoparticles, the higher will be the acceptable and desirable loading in weight percent.

Vehicles

The security features of the present invention preferably are formed, printed, or created from inks comprising a vehicle in addition to the metallic particles and/or metallic nanoparticles. In one embodiment, these inks further comprise an anti-agglomeration substance, for example, a polymer or surfactant, as described above. The vehicle for use in the inks, preferably the ink jet inks or digital inks, is preferably a liquid that is capable of stably dispersing the metallic particles and/or metallic nanoparticles more preferably the metallic particles and/or metallic nanoparticles comprising an anti-agglomeration substance. For example, vehicles are preferred that are capable of affording an ink dispersion that can be kept at room temperature for several days or even one, two, three weeks or months or even longer without substantial agglomeration and/or settling of the metallic particles and/or metallic nanoparticles. To this end, it is also preferred for the vehicle to be compatible with the surface of the metallic particles and/or metallic nanoparticles. It is particularly preferred for the vehicle to be capable of dissolving the anti-agglomeration substance, if present, to at least some extent, without removing it from the metallic particles and/or metallic nanoparticles. In one embodiment, the vehicle comprises (or predominantly consists of) one or more polar components (solvents) such as, e.g., a protic solvent, or one or more aprotic, non-polar components, or a mixture thereof. The vehicle, in an embodiment, is a solvent selected from the group consisting of alcohols, polyols, amines, amides, esters, acids, ketones, ethers, water, saturated hydrocarbons, unsaturated hydrocarbons, and mixtures thereof.

Where the security features of the invention, whether reflective or conductive or a combination thereof, are printed, formed or created through direct-write printing, such as ink-jet printing or digital printing, the vehicle is preferably selected to effectively work with direct-write printing tool(s), such as, e.g., an ink-jet head, a digital head, and cartridges, particularly in terms of viscosity and surface tension of the ink composition.

In a preferred aspect, the vehicle comprises a mixture of at least two solvents, preferably at least two organic solvents, e.g., a mixture of at least three organic solvents, or at least four organic solvents. The use of more than one solvent is preferred because it allows, inter alia, to adjust various properties of a composition simultaneously (e.g., viscosity, surface tension, contact angle with intended substrate etc.) and to bring all of these properties as close to the optimum values as possible. In one preferred embodiment, the vehicle comprises a mixture of ethylene glycol, ethanol and glycerol. Non-limiting examples of vehicles are disclosed in, e.g., U.S. Pat. Nos. 5,853,470; 5,679,724; 5,725,647; 4,877,451; 5,837,045 and 5,837,041, the entire disclosures of which are incorporated by reference herein.

As discussed in more detail below, it is desirable to also take into account the requirements, if any, imposed by the deposition tool (e.g., in terms of viscosity and surface tension of the ink) and the surface characteristics (e.g., acidity, hydrophilicity or hydrophobicity) of the intended substrate in selecting the vehicle of choice. Although the desired ink viscosity may depend greatly on the specific deposition tool implemented, inks used to form the security features of the present invention, particularly those intended for ink-jet printing with a piezo head, preferably have a viscosity (measured at 20° C.) that is not lower than about 10 centipoise (cP), e.g., not lower than about 12 cP, or not lower than about 15 cP, and not higher than about 50 cP, e.g., not higher than about 40 cP, not higher than about 30 cP, or not higher than about 25 cP. Preferably, the viscosity of the ink compositions show only small temperature dependence in the range of from about 20° C. to about 40° C., e.g., a temperature dependence of not more than about 0.4 cP/° C. For use in an ink-jet printing process, the viscosity of the inks preferably is in the range of from about 10 cP to about 40 cP, preferably from about 10 cP to about 35 cP, and most preferably from about 10 cP to about 30 cP, preferably less than about 25 cP. For use in an aerosol jet atomization processes, the viscosity of the ink is preferably not greater than about 20 cP. In automated syringe processes, the viscosity of the ink is preferably up to about 5000 cP. For use in a gravure printing process, the viscosity of the inks preferably is in the range of from about 15 cP to about 100 cP. For use in a lithographic or offset printing process, the viscosity of the inks preferably is in the range of from about 5,000 cP to about 50,000 cP.

Further, the preferred inks used to form the security features of the present invention exhibit preferred surface tensions (measured at 20° C.) of not lower than about 20 dynes/cm, e.g., not lower than about 25 dynes/cm, or not lower than about 30 dynes/cm, and not higher than about 40 dynes/cm. In one embodiment, the ink composition or formulation used to form the security features comprises metallic particles and/or metallic nanoparticles, and has a viscosity less than about 60 cP, e.g., less than about 30 cP or less than about 20 cP.

Optional Additives

The inks, preferably the ink jet inks or digital inks comprising the metallic particles and/or metallic nanoparticles, used to form the security features of the present invention, preferably the reflective and/or conductive security features, in an embodiment can further comprise one or more additives, such as, but not limited to, adhesion promoters, rheology modifiers, surfactants, wetting angle modifiers, humectants, crystallization inhibitors, binders, dyes/pigments and the like.

In one embodiment, the ink, preferably the ink jet ink or digital ink, comprises an adhesion promoter, which facilitates adhesion of the metallic particles, preferably the metallic nanoparticles, in the ink to the substrate on which it is ultimately deposited. Non-limiting examples of adhesion promoters include shellac, latex, acrylates, other polymers, metal or a main group oxide (e.g., SiO₂, CuO). Additional examples of adhesion promoters are described in U.S. Pat. No. 5,750,194, which is herein fully incorporated by reference. The anti-agglomeration substance that optionally is included with the metallic particles and/or metallic nanoparticles may also act as an adhesion promoter. Additionally, although less preferred, the adhesion promoter or any of the above additives can be added directly to the substrate.

In one embodiment, the ink, preferably the ink jet ink or digital ink, in addition to the metallic particles and/or metallic nanoparticles, further comprises a rheology modifier, which reduces spreading of the ink after deposition. Non-limiting examples of rheology modifiers include SOLTHIX 250 (Avecia Limited), SOLSPERSE 21000 (Avecia Limited), styrene allyl alcohol (SAA), ethyl cellulose, carboxy methylcellulose, nitrocellulose, polyalkylene carbonates, ethyl nitrocellulose, and the like.

In one embodiment, the ink, preferably the ink jet ink or digital ink, in addition to the metallic particles and/or metallic nanoparticles, further comprises a binder, which increases the durability of the ultimately formed features. Non-limiting examples of binders include latex, shellac, acrylates, and the like. Furthermore, polymers such as, but not limited to, e.g., polyamic acid polymers, acrylic polymers, PVP, co-polymers of PVP (alkanes, styrenes, etc.), polyfluorosilicate polymers, polyflourinated telomers (including Zonyl™ products manufactured by E.I. DuPont de Nemours & Co.), and co-polymers of styrene acrylics (e.g., those sold under the Joncryl™ trade name available from Johnson Polymer Corp.) can improve the adhesion of the metallic particles and/or metallic nanoparticles to a polymer substrate, as can substances such as coupling agents (e.g., titanates and silanes). These substances can function to increase adhesion of the feature to the substrate, as well as to decrease the interaction of water with the feature thereby rendering the feature more durable. Cohesion promoters may also be included in the ink to improve security feature durability.

Substrates

The above-described inks, preferably ink jet inks or digital inks, are printed, deposited, or otherwise placed on any of a variety of substrates having myriad surface characteristics, thereby forming, placing, or printing the security features of the present invention, preferably the reflective and/or conductive security features, on the substrate surface.

In a preferred embodiment, the security feature, preferably the reflective security feature, of the invention is printed using an ink composition or formulation comprising one or more metallic particles, preferably metallic nanoparticles, onto a substrate having a surface upon which the security feature is formed. In this embodiment, the printing is preferably performed by a direct write tool, e.g., an ink jet printer, print head, cartridge or the like, and the ink composition or formulation is jettable through an ink jet head or cartridge. In a most preferred embodiment, the security feature, preferably the reflective and/or conductive security feature, is formed from an ink formulation at a low temperature. Thus, the selection of substrates upon which the security feature of the invention is formed include those substrates having a low softening or melting point such as paper, polymers, etc. According to a preferred aspect of the present invention, the substrate onto which the metallic particle- and nanoparticle-containing ink composition or formulation is deposited has a softening and/or decomposition temperature of not higher than about 300° C., e.g., not higher than about 250° C., not higher than about 225° C., not higher than about 200° C., not higher than about 185° C., not higher than about 150° C., or not higher than about 125° C.

Non-limiting examples of substrates that are particularly advantageous for printing on or incorporating into the security feature, preferably the reflective and/or conductive security feature, include substrates or substrate surfaces comprising one or more of the following: a fluorinated polymer, polyimide, epoxy resin (including glass-filled epoxy resin), polycarbonate, polyester, polyethylene, polypropylene, bi-oriented polypropylene, mono-oriented polypropylene, polyvinyl chloride, ABS copolymer, wood, paper, metallic foil, glass, banknotes, linen, labels (e.g., self adhesive labels, etc.), synthetic paper, flexible fiberboard, non-woven polymeric fabric, cloth and other textiles. Other particularly advantageous substrates include cellulose-based materials such as wood, paper, cardboard, or rayon, and metallic foil and glass (e.g., thin glass). Although the compositions of the present invention are particularly advantageously useful for temperature-sensitive substrates, it is to be appreciated that other substrates such as, e.g., metallic and ceramic substrates, are useful as well.

In one embodiment, the substrate comprises a coating. In particular, the substrates discussed above, for example, a natural or synthetic paper, have been coated with specific layers to enhance gloss and/or accelerate the infiltration of ink or ink vehicle used in the inks, particularly the digital inks. Preferred examples of coatings, preferably glossy coatings for ink-jet substrates such as paper (e.g., photo paper), comprise silica, alumina, silica alumina and/or fumed alumina. In a preferred embodiment, the surface of a paper has a pH less than 5.

In various embodiments, the substrate includes one or more images on its surface. The images may be formed from a printing process selected from the group consisting of direct write printing (e.g., ink jet or digital printing), intaglio printing, gravure printing, offset printing, lithographic printing and flexographic printing processes. For holograms or some other types of images, the image may be formed, at least in part, through a laser etching process. The ability to print, create and form the security features of the invention on a substrate having an image (e.g., printed image, hologram, or the like) provides an additional level of document security not heretofore available. In addition, being able to individualize a document, a tag, etc., with variable information provides even further anti-counterfeiting measures not recognized or available until now. As used herein, the term “variable information” means information that is individualized for a product unit, such as, but not limited to, serialized data. For example, a serial number is one non-limiting type of variable information. Other types of variable information include: counters, lettering, sequential symbols, alphanumeric variable information, non-serialized variable information (variable information that is not sequential), and combinations thereof.

Additionally, the image on the surface of a substrate may or may not have a longitudinally varying topography. By longitudinally varying topography it is meant that the image has portions, e.g., surfaces, which extend, preferably in varying degrees, in a direction perpendicular to the substrate surface. The longitudinally extending surfaces may be formed, for example, as regions in which more ink was applied to the substrate surface to form the image. That is, some portions of the image, e.g., regions of one color, may have a greater longitudinally extending topography than other portions of the image, e.g., regions of a different color. The ability to print on non-uniform surfaces, and in vias, trenches and cavities also provides additional anti-counterfeiting measures not available with conventional inks or processes.

Ink Deposition

As indicated above, the security features, for example, the reflective and/or conductive security features of the present invention, preferably are formed through a direct-write printing process, although other printing processes may also be used to form the security features, such as, but not limited to, pen/syringe, continuous or drop on demand ink-jet, droplet deposition, spraying, offset printing, flexographic printing, lithographic printing, gravure printing, intaglio printing, and others, discussed in more detail below. The security features of the invention can also be formed by depositing ink by dip-coating or spin-coating, or by pen dispensing onto rod or fiber type substrates.

As indicated above, the metallic particle and/or metallic nanoparticle-containing inks used to form the security features of the present invention, preferably the reflective security features, can be deposited onto the surface of a substrate using a variety of tools such as, for example, low viscosity deposition tools. As used herein, a low viscosity deposition tool is a device that deposits a liquid or liquid suspension onto a surface by ejecting the composition through an orifice toward the surface without the tool being in direct contact with the surface. The low viscosity deposition tool is preferably controllable over an x-y grid, or an x-y-z grid, referred to herein as a “direct-write” deposition tool. A preferred direct-write deposition tool according to the present invention is an ink-jet device or printer. Other examples of direct-write deposition tools include aerosol jets and automated syringes, such as the MICROPEN tool, available from Ohmcraft, Inc., of Honeoye Falls, N.Y.

As mentioned previously, the ability to print a reflective security feature comprising variable information at commercially acceptable rates has not heretofore been possible. Direct write printing processes, such as ink jet printing processes, are particularly preferred according to the present invention in that they provide the ability to form security features, preferably reflective features, comprising variable information as well as the ability to form, print, create such security features at a commercially acceptable rate. The ability to incorporate, for example, a unique serial number, feature or the like to a security feature is a desirable anti-counterfeiting measure. The inks comprising the metallic particles and/or metallic nanoparticles provide for digital printing that allows for the printing of variable information in the security features of the invention, especially the reflective security features of the invention. In addition, the ability to print on substrates having low melting point temperatures such as paper and the like have made this possible even further.

An ink suitable for a commercial direct write printing process should have numerous characteristics and properties including a precise loading of particles, a correct viscosity, and appropriate binders, adhesion promoters, etc. It was surprisingly discovered that the inks of the present invention are capable of being used in commercial printing equipment to print the security features of the invention at rapid, commercially acceptable, rates. The security features, preferably the reflective security features, of the present invention in one embodiment, are printed using a direct write printing process on a moving substrate, e.g., an ink jet or digital printing process, at a rate greater than about 0.1 m/s, e.g., greater than about 0.5 m/s, greater than about 1 m/s, greater than about 5 m/s, greater than about 10 m/s, greater than about 15 m/s or even greater than about 20 m/s, based on the rate of movement of the substrate. Preferably, the security features printed at these speeds have a very high resolution (preferably greater than about 200 dpi (79 dpcm), greater than about 300 dpi (118 dpcm), or greater than about 400 dpi (157 dpcm) in the x and/or y directions). As used in this context, the terms “digital printing,” “digitally printed” and variations thereof refer to a non-contact printing processes utilizing digital data, preferably capable of printing variable information. In one embodiment, the rate at which the security features are formed refers to the speed at which the substrate passes through the ink jet printer as the security feature is printed thereon, or the equivalent rate if the substrate remains stationary as the printing head(s) move over the substrate surface. For these and other reasons, direct write printing processes, devices and tools, such as ink-jet processes, devices and tools, are highly desirable means for depositing the above-described inks onto a substrate surface. In another embodiment, the number of security features, preferably reflective security features are capable of being printed using the inks of this invention at a rate greater than about 5,000 security features per minute, preferably greater than about 10,000 security features per minute, and most preferably greater than about 20,000 security features per minute. Of course, the rate at which security features are printed will depend, in part, on the size of the security features. Furthermore, in this embodiment, the security features preferably comprise reflective security features, preferably comprising variable information.

In one aspect, the process for forming a security feature, e.g., reflective security feature, of the present invention comprises the steps of: (a) providing an ink comprising metallic particles and/or metallic nanoparticles; and (b) direct write printing the ink on a substrate to form the security feature. As discussed above, at least a portion of the security feature optionally displays variable information, e.g., covert and/or overt variable information. The substrate in this embodiment can be any of those previously described herein. Preferably, the substrate comprises paper, plastic or a combination thereof. In addition, in this embodiment, it is further contemplated that the surface of the substrate optionally contains one or more images upon which the security feature of the invention is printed, in whole or in part. The one or more images in an embodiment may comprise a printed image, a hologram or the like.

One problem encountered by some conventional direct write, e.g., ink jet, printing processes is that the temperature of the printing head(s) and/or cartridges tends to vary during continuous high speed printing, thereby undesirably changing one or more properties, e.g., viscosity and/or surface tension, of an ink that is designed to be printed at ambient temperature. This change in properties of the ink may have deleterious effects such as changing print quality and performance, tail formation as viscosity drops, and clogging and failure of the print head as viscosity rises.

In one aspect of the invention, the ink composition or formulation of the metallic particle and/or metallic nanoparticle-containing ink used in the printing process of the invention is designed to be printed at a substantially constant, elevated temperature. For example, the ink may be modified to include a high viscosity component (e.g., humectant) and/or a polymer that can serve a dual function of increasing the durability of the as-formed security feature as well as improving ink performance at elevated temperatures. Thus, in one embodiment, the direct write printing step occurs at a temperature greater than ambient temperature, e.g., greater than about 25° C., greater than about 30° C. or greater than about 35° C. In terms of upper range limitations, optionally in combination with these lower range limitations, the direct write printing step optionally occurs at a temperature less than about 40° C., less than about 35° C. or less than about 30° C. Thus, in one aspect, the step of direct write printing the ink comprises ink jet printing the ink from an ink reservoir, through a print head, and onto a substrate, wherein the temperature of the ink reservoir or print head is greater than about 25° C., greater than about 30° C., or greater than about 35° C. These temperatures refer to the temperature of either the print head or the ink reservoir during printing, as determined by a thermocouple measurement. Another example of a method for depositing the ink, e.g., an ink jettable or digital ink, employs a heated ink-reservoir and/or print head to decrease the viscosity of the ink composition. It has been surprisingly discovered that heating the ink, the ink jet head, or both, and operating at elevated temperatures reduces temperature fluctuations resulting in a substantially more reliable direct write process. Optionally, the head and/or ink are heated when printing at high speeds as may be necessary when commercially printing the security features of the invention, especially when using a ink jet head, preferably a piezo head operating at high frequencies such as greater than 3,000 μl, preferably greater than 5000 s⁻¹, preferably greater than 7000 s⁻¹, even more preferably greater than 9000 s⁻¹, and yet even more preferably greater than 10,000 s⁻¹, and most preferably greater than 12,000 s⁻¹.

Thus, in an embodiment, the invention relates to a process for printing a security feature, preferably a reflective security feature, using a direct write printer, such as ink jet printer, at high speeds or rates where the process optionally involves the step of heating a print head, such as a piezo head, or an ink used in a print head, preferably a piezo head. In a preferred embodiment, the temperature of the ink or the ink jet head is maintained at a temperature of from above room temperature to about 200° C., preferably from about 30° C. to about 100° C., more preferably from about 30° C. to about 40° C., and most preferably from about 30° C. to about 35° C.

Although continuous printing of the inks of the present invention may occur at elevated temperatures, the continuous printing preferably occurs at a substantially constant temperature, e.g., ±6° C., more preferably ±4° C., more preferably ±2° C., more preferably ±1° C., and most preferably ±0.5° C. As indicated above, the temperature of the printing process will initially increase until it reaches the above-described relatively constant elevated temperature. Thus, the term, “continuous printing,” in this context, refers to a period of time after the ink and/or print head has obtained this relatively constant elevated temperature, e.g., after the temperature of the ink and/or print head has stabilized after start-up.

In a preferred embodiment, a direct write deposition tool, preferably an ink-jet device, is utilized in combination with an ink, preferably an ink jettable ink or digital ink, to form the security features, preferably the reflective security features, of the present invention. Ink-jet devices operate by generating droplets of ink and directing the droplets toward a substrate's surface. Each drop generated by the ink-jet head and delivered to a substrate surface includes approximately 5 to about 100 picoliters of the ink (e.g., from about 10 to about 100 picoliters or from about 25 to about 100 picoliters of ink), e.g., ink jet ink or digital ink. Variable drop volume ink jet print heads may also be employed. Each drop preferably is substantially spherical, although non-spherical droplets may be used to create an unusual substructure (e.g., each drop forming a head-tail structure) in the printed feature thereby adding a further level of covert security. The position of the ink-jet head is carefully controlled and can be highly automated so that discrete patterns of the composition can be applied to the surface. Ink-jet printers are capable of printing at a rate of about 1000 drops per jet per second or higher (e.g., greater than 3,000 drops per second, greater than about 5,000 drops per second, greater than about 7,000 drops per second, greater than about 9,000 drops per second, greater than about 10,000 drops per second, or even greater than about 12,000 drops per second) and can print various features including linear features with good resolution (e.g., a resolution greater than about 200 dpi (79 dpcm), greater than about 300 dpi (118 dpcm), or greater than about 400 dpi (157 dpcm) in the x and/or y directions) at commercially acceptable rates (provided above).

Typically, an ink-jet device includes an ink-jet head, and/or cartridge or other ink delivery system with one or more orifices having a diameter of not greater than about 100 μm, such as from about 5 μm to about 75 μm. Droplets are generated and are directed through the orifice toward the surface being printed. Ink-jet printers typically utilize a piezoelectric driven system to generate the droplets, although other variations are also used. Thermal and bubblejet ink jet printing approaches may also be used. Ink-jet devices are described in more detail in, for example, U.S. Pat. Nos. 4,627,875 and 5,329,293, the disclosures of which are incorporated by reference herein in their entireties.

In another embodiment, the security features of the invention, preferably the reflective security features, are formed, printed, deposited, or otherwise created from an ink comprising metallic particles and/or metallic nanoparticles using an aerosol jet deposition process. Aerosol jet deposition allows the formation of security features having a minimum features size of, e.g., not greater than about 200 μm, such as not greater than about 150 μm, not greater than about 100 μm and even not greater than about 50 μm. In aerosol jet deposition, the metallic particles and/or metallic nanoparticle-containing ink compositions or formulations are aerosolized into droplets and the droplets are transported to the substrate in a flow gas through a flow channel. Examples of aerosol jet deposition include those disclosed in U.S. Pat. Nos. 6,251,488; 5,725,672 and 4,019,188, the entire disclosures of which are incorporated by reference herein.

The droplets may be deposited onto the surface of the substrate by inertial impaction of larger droplets, electrostatic deposition of charged droplets, diffusional deposition of sub-micron droplets, interception onto non-planar surfaces and settling of droplets, such as those having a size in excess of about 10 μm.

In one embodiment, the invention is directed to a direct write printing process for printing a security feature utilizing a direct write printer having a direct write head, the direct write head capable of generating and/or depositing droplets of an ink on a substrate, the ink comprising metallic particles and/or metallic nanoparticles, the process comprising the steps of operating the direct write head at greater than 5000 s⁻¹ such that each drop of ink generated comprises about 5 picoliters to about 100 picoliters of the ink (e.g., from about 10 to about 100 picoliters, or from about 25 to about 100 picoliters of ink), and wherein the substrate is moving at a rate of greater than 1 m/s. In addition, the process above optionally further comprises the step of heating the ink and/or the direct write head. In a preferred aspect of this embodiment, the temperature of the ink or the direct write head is maintained at a temperature of from above room temperature to about 200° C., preferably from about 30° C. to about 100° C., more preferably from about 30° C. to 40° C., and most preferably from about 30° C. to 35° C. In this embodiment, the direct write head has one or more orifices having a diameter of not greater than about 100 μm, e.g., from about 50 μm to about 75 μm. Additionally, in this embodiment, the feature preferably has a size less than about 200 μm, preferably less than about 150 μm, more preferably less than 100 μm, and most preferably less than about 50 μm. Also, in this embodiment, the feature is a security feature, preferably a reflective or conductive feature, and most preferably a reflective security feature, optionally further comprising variable information. These security features are useful on labels, tags, documents, currency, or the like, which may be affixed or otherwise secured to virtually any article of manufacture. In another aspect of this embodiment, the substrate comprises a coating, or the substrate comprises one or more images, for example a hologram. In one embodiment, the direct write printer comprises an ink jet device, and optionally the direct write head comprises a piezo head.

In another embodiment, the security features of the invention, preferably the reflective security features, are formed, printed, deposited, or otherwise created from an ink comprising metallic particles and/or metallic nanoparticles using a variety of other techniques including, but not limited to, intaglio, roll printer, spraying, offset printing, dip coating, spin coating, and other techniques that direct discrete units of fluid or continuous jets, or continuous sheets of fluid to a surface.

Other examples of advantageous printing methods for the compositions of the present invention include lithographic printing and gravure printing. For example, gravure printing can be used with metallic particles and metallic nanoparticle containing ink compositions or formulations having a viscosity of up to about 500 cP. The gravure method can deposit features having a minimum features size of from about 1 μm to about 25 μm and can deposit such features at a high rate of speed, such as up to about 700 meters per minute. The gravure process also comprises the direct formation of patterns onto the surface. Thus, while the inks of the invention are preferably used in a direct write printing process, the inks of the invention may also be used in a gravure printing process, which provides for the ability to print fine features through microengraving of a gravure cylinder. This embodiment enables the printing of very fine reflective security features using inks that comprise metallic particles and/or metallic nanoparticles to wet the finely engraved gravure cylinder features.

In another embodiment, the security features of the invention, preferably the reflective security features, are formed, printed, deposited, or otherwise created from an ink comprising metallic particles and/or metallic nanoparticles using a lithographic printing process. In a lithographic process, an inked printing plate contacts and transfers a pattern to a rubber blanket and the rubber blanket contacts and transfers the pattern to the surface being printed. A plate cylinder first comes into contact with dampening rollers that transfer an aqueous solution to the hydrophilic non-image areas of the plate. A dampened plate then contacts an inking roller and accepts the ink only in the oleophilic image areas. Thus, while the inks of the invention are preferably used in a direct write printing process, the inks of the invention may also be used in a lithographic process, which provides for highly reflective security features that can be defined by a high resolution pattern using these processes.

Using one or more of the foregoing deposition techniques, it is possible to deposit the above-described inks on one side or both sides of a substrate. Further, the processes can be repeated to deposit multiple layers of the same or different metallic nanoparticle compositions on a substrate.

In one preferred embodiment, the ink, which comprises metallic particles, preferably metallic nanoparticles, is advantageously confined on the substrate, thereby enabling the formation of security features having a small minimum feature size, the minimum feature size being the smallest feature dimension in the x-y axis, such as the width of a line or diameter of a circle. In accordance with the direct-write processes, the present invention comprises the formation of security features, preferably reflective security features, optionally having a small minimum feature size. For example, the method of the present invention can be used to fabricate security features having a minimum feature size of not greater than about 200 μm, e.g., not greater than about 150 μm, not greater than about 100 μm, or not greater than about 50 μm. These feature sizes can be provided using ink-jet printing and other printing approaches that provide droplets or discrete units of composition to a surface. The preferred metallic particle and nanoparticle-containing inks used to form the security features of the present invention can be confined to regions on a substrate having a width of not greater than about 200 μm, preferably not greater than about 150 μm, e.g., not greater than about 100 μm, or not greater than about 50 μm.

As discussed above, the substrate on which the ink, e.g., ink jet or digital ink, is printed optionally includes one or more images thereon. Thus, the printing step optionally comprises direct write printing the ink onto a substrate surface having an image to form the security feature for enhancing the anti-counterfeiting security of the security feature. Preferably, the ultimately formed printed security feature at least partially overlaps the one or more images. The underlying image may be selected from the group consisting of a hologram, a black and white image, a color image, a watermark, a UV fluorescent image, text and a serial number, or a combination thereof. Printing the security feature on top of at least a portion of the one or more images is desirable to form a security feature having a photo-obscuring effect, described in more detail below.

The underlying substrate image preferably is formed before the metallic particle and/or nanoparticle-containing ink is printed on the substrate to form the security feature, e.g., reflective security feature, of the present invention. In various embodiments, the substrate image may be formed from a printing process selected from the group consisting of direct write printing (e.g., ink jet or other digital printing), intaglio printing, gravure printing, lithographic printing and flexographic printing processes. The image may or may not be formed (in whole or in part) from the same ink used to form the security feature that at least partially overlaps the image. For holograms or some other types of images, the image may be formed, at least in part, through a laser etching process. Additionally, the image optionally present on the substrate surface may or may not have a longitudinally varying topography, as described above. In another embodiment, the inks comprising the metallic particles and/or metallic nanoparticles are utilized to print reflective security features using any one of or a combination thereof of the following printing technologies: ink jet printing, intaglio, gravure, off set printing and the like.

Treating the Ink

Simultaneously with or after the above-described printing step, e.g., immediately after the ink deposition (printing) step, the process optionally further comprises the step of treating and/or curing the ink deposited on the substrate. As used herein, the term “treating” means processing, e.g., by heating or by applying radiation (e.g., IR, UV or microwave radiation), under conditions effective to change a physical or chemical property of the composition (deposited ink) being treated or otherwise modifying the composition, e.g., by forming another layer (such as a coating layer) thereon. Thus, in one aspect, the process further comprises the step of applying heat, ultraviolet radiation, infrared radiation and/or microwave radiation to the printed or otherwise deposited ink. Non-limiting examples of methods for treating the deposited ink in this manner include methods employing a V, IR, microwave, heat, laser or a conventional light source. The temperature of the deposited ink can be raised using hot gas or by contact with a heated substrate. This temperature increase may result in further evaporation of vehicle and/or other species. A laser, such as an IR laser, can also be used for heating. An IR lamp, a hot plate or a belt furnace can also be utilized. In other aspects, the treating includes, for example, freezing, melting, radiating and otherwise modifying the properties of the applied ink, such as viscosity and/or surface tension, with or without chemical reactions or removal of material from the applied ink. The treating step may be desired, for example, to form a more permanent security feature (e.g., by curing the deposited ink) and/or to form a conductive security feature.

In an embodiment, the deposited inks used to form the security features of the invention, e.g., ink jet or digital inks, are processed for very short times. Short heating times can advantageously prevent damage to the underlying substrate. For example, thermal processing times for ink deposits forming security features having a dry thickness on the order of about 200 nm may be not greater than about 100 milliseconds, e.g., not greater than about 10 milliseconds, or not greater than about 1 millisecond. The short heating times can be provided using laser (pulsed or continuous wave), lamps, or other radiation. Particularly preferred are scanning lasers with controlled dwell times. When processing with belt and box furnaces or lamps, the hold time may often be not longer than about 60 seconds, e.g., not longer than about 30 seconds, or not longer than about 10 seconds. The preferred heating time and temperature will also depend on the nature of the desired feature, e.g., of the desired security feature. It will be appreciated that short heating times may not be beneficial if the solvent or other constituents boil rapidly and form porous-type or other type defects in the feature.

In one embodiment, the inks, which comprise metallic particles and/or nanoparticles, further comprise a photoactive reagent curable by irradiation with UV light. The photoactive reagent may, for example, be a monomer or low molecular weight polymer that polymerizes, optionally in the presence of a photoinitiator, on exposure to UV light resulting in a robust, insoluble metallic reflective layer.

In one particular aspect, the invention is directed to a security feature, preferably a reflective security feature, that is UV curable, but does not comprise a UV curable organic composition (e.g., does not comprise an organic UV curable vehicle, monomer or polymer). Thus, in an embodiment, the invention is to a UV curable security feature comprising metallic particles and/or metallic nanoparticles that is free of a UV curable organic composition (e.g., free of UV curable vehicle). Without being bound by a particular theory, in this aspect, it is believed that the plasmon resonance of the metallic (e.g., silver) particles and/or metallic nanoparticles, is coincident with the UV radiation causing heating of the surrounding vehicle. This heating results in the vaporization of the vehicle from the substrate surface and thus, the formation of a dry, highly reflective feature. For example, the UV curable security feature is curable to form a sintered network of the metallic nanoparticles. Without being bound by a particular theory, it is believed that the UV radiation increases sintering of adjacent metallic particles and/or nanoparticles in the deposited ink, improving reflectivity and conductivity of the ultimately formed security feature.

In a further aspect of the present invention, the deposited ink, e.g., ink jet or digital ink, may be treated, e.g., cured, by compression to form the security feature, e.g., reflective security feature, of the present invention. This can be achieved by exposing the substrate containing the deposited ink to any of a variety of different processes that “weld” the metallic particles and/or metallic nanoparticles in the ink. Non-limiting examples of these processes include stamping and roll pressing.

In one aspect of the present invention, the deposited ink is converted to a printed security feature, e.g., printed reflective security feature, at temperatures of not higher than about 300° C., e.g., not higher than about 250° C., not higher than about 225° C., not higher than about 200° C., or not higher than about 185° C. In many cases, it will be possible to form a desirable security feature, e.g., reflective security feature (optionally exhibiting some desired degree of conductivity), at temperatures of not higher than about 150° C., e.g., at temperatures of not higher than about 125° C., or even at temperatures of not higher than about 100° C.

If conductivity is desired in the security feature of the present invention, for example as an added security element (described in more detail below), it is beneficial for a weight majority, preferably at least about 60 weight percent, at least about 70 weight percent, at least about 80 weight percent or at least about 90 weight percent of the metallic particles and/or metallic nanoparticles derived from the ink to be at least partially, preferably fully, sintered (or necked) to at least one adjacent metallic nanoparticle in the ultimately formed security feature. This sintering may occur at room temperature or during treating of the deposited ink, e.g., with heat, IR radiation, UV radiation, microwave radiation, pressure, or other radiation.

The deposited and treated material, e.g., the security feature, preferably the reflective security feature, also may be post-treated. The post-treatment can, for example, include cleaning and/or encapsulation of the security feature (e.g., in order to protect the deposited material from oxygen, water or other potentially harmful substances) or other modifications. After the ink, e.g., ink jet or digital ink, has been deposited on the substrate and preferably treated to form the security feature, e.g., reflective security feature, of the present invention, it may be desired to form a protective layer over at least a portion of the security feature in order to protect it from being damaged and/or oxidized.

Thus, in another non-limiting example, a protective layer may be printed or applied on top of the printed security feature. This protective layer provides protection against, for example, pressure, abrasion, water or chemical agents that are present in the gas or liquids to which the printed structure may be exposed after it is printed. The protective layer may also protect the feature against exposure to human touch, perspiration, or the environment, e.g., humidity, etc. For example, a lacquer, an enamel, a glass, a glass/metal composite, or polymer protective substance may be applied (optionally printed) as an overcoat on top of the security feature, e.g., reflective security feature, to inhibit, for example, oxidation or blackening of the security feature, and may provide improved scratch and abrasion resistance. Alternatively, lacquers, glass and polymer protective substances are added to the ink compositions in combination with the metallic particles and/or metallic nanoparticles of the invention. A variety of protective substances can be added to the already printed security feature, or in the inks themselves prior to printing the security features, to impart durability (particularly water durability) and increase the lifetime of the security feature. Non-limiting list of exemplary protective substances useful as an overcoat or for inclusion into the ink itself includes lacquers, fluorosilicates, fluorinated polymers (e.g., Zonyl products), shellac (or other similar clear coat technologies), acrylates, UV curable acrylates, polyurethanes, etc., or a combination thereof. The protective layer optionally is deposited on the security feature by a printing process selected from the group consisting of direct write printing (e.g., ink jet or digital printing), intaglio printing, gravure printing, offset printing, lithographic printing and flexographic printing processes. Of course, the protective layer may be formed on the security feature by any other conventional coating process, well-known to those skilled in the art. In one embodiment, the protective substance is used in the ink for printing the security feature, and subsequently the security feature is printed with the same or different protective substance. It is possible that if two different protective substances are utilized in this way that they react to form a third protective substance.

Security Features

The above-described inks, e.g., ink jet inks or digital inks, and processes of the present invention may advantageously be used, for example, for the fabrication of printed security features, preferably printed reflective security features, comprising metallic particles, preferably metallic nanoparticles. The security features may be used to authenticate virtually any article of manufacture, such as, but not limited to, any branded product, perfume, drugs, tobacco or alcohol products, bottles, clothing (e.g., shirts, pants, jeans, blouses, skirts, dresses, socks, hats, undergarments, etc.), food packaging or containers, sporting goods, posters, and the like, and may be used in documents, for example, passports, bonds, tickets, tax stamps, banknotes, a brand authentication tag, and the like.

In an aspect, the invention is directed to a digitally printed security feature. The security feature may be electrically conductive or non-conductive, magnetic or non-magnetic, and may be transparent, semi-transparent and/or reflective in the visible light range and/or in any other range such as, e.g., in the UV and/or IR ranges. As used herein, the term “semitransparent” means capable of allowing at least some light to pass therethrough, e.g., through openings and/or through a translucent layer, while optionally absorbing a portion of the light. As used herein, the term “reflective” means exhibiting a substantially specular (or mirror-like) characteristic, while optionally absorbing some amount (e.g., certain wavelengths) of light. The terms “feature” and “structure” as used herein and in the appended claims include any two- or three-dimensional structure including, but not limited to, a line, a shape, an image, a dot, a patch, a continuous or discontinuous layer (e.g., coating) and in particular, any structure that is capable of being formed on any substrate. As used herein, the term “security feature” means a feature, as defined above, that is placed on an article (e.g., a tag or label, a document such as a passport, check, bond, banknote, currency, ticket, etc.), directly or indirectly, for the purpose of authenticating the article.

The present invention, in one embodiment, relates to security features comprising metallic particles, preferably metallic nanoparticles, and more preferably to a security feature that comprises metallic nanoparticles where the security feature is at least partially, preferably fully, reflective. In an embodiment, the security features of the invention, preferably the reflective security features, are comprised of predominantly, e.g., greater than 80% or greater than 90%, metallic particles and/or metallic nanoparticles (excluding any overcoat and/or protective layers). In another aspect, the present invention relates to a digitally printed security feature, preferably a digitally printed security feature that is reflective. The reflective security features of the present invention provide various optical security features that make the reproduction of the security features particularly difficult.

The invention is further directed to processes for forming security features, preferably reflective security features, from metallic particles, preferably metallic nanoparticles. Additionally or alternatively, the invention is to a process for forming a digitally printed security feature. The security feature preferably is formed from an ink comprising the metallic particles, preferably metallic nanoparticles. The ink, in one embodiment, is a digital ink comprising metallic particles, preferably metallic nanoparticles, and is capable of being digitally printed through a digital ink jet printer head or cartridge. The process, in one exemplary embodiment, comprises a first step of providing an ink, preferably a digital ink, comprising metallic particles and/or metallic nanoparticles. The process includes a second step of direct write printing, preferably ink jet printing, the ink, preferably a digital ink, onto a substrate to form a security feature, preferably a reflective security feature. The substrate optionally includes an image thereon that is covered, at least in part, by a security feature having a photo-obscuring effect on the underlying image, as described above. As discussed above, depending on the particular ink formulation, the process optionally also includes a step of treating the printed ink with, for example, heat, microwaves, ultraviolet radiation and/or infrared radiation, under conditions effective to cause the printed ink to cure. In a preferred embodiment, the metallic particles and/or the metallic nanoparticles comprise a metal (e.g., in the form of an elemental metal, alloy, or a metal-containing compound) or a compound having metallic characteristics, and optionally an anti-agglomeration agent, preferably a polymer, and most preferably a hetero-atom containing polymer.

The security features of the present invention comprise a wide variety of uses for purposes of providing security and authenticity in many different applications. For example, with the advent and growth of desktop publishing and color-photocopiers, the opportunities for document and coupon fraud have increased dramatically. The security features of the present invention have utility in a variety of areas including coupon redemption, inventory security, currency security, compact disk security and driver's license and passport security. The security features of the present invention can also be utilized as an effective alternative to magnetic strips. Presently, magnetic strips include identification numbers such as credit card numbers that are programmed at the manufacturer. These strips are prone to failure and are subject to fraud because they are easily copied or modified. To overcome these shortcomings, a conductive security feature in the form of a circuit can be printed on the substrate and encoded with specific consumer information. Thus, the present invention can be used to improve the security of credit cards, ATM cards and any other tracking card, which uses magnetic strips as a security measure.

In another security application aspect of the present invention, security features, e.g., reflective security features, can be printed on various articles to produce overt security features. For example, such features are useful in applications that provide security to currency (e.g. bank notes) or brand protection to branded goods. By way of non-limiting example, a unique metallic, reflective feature may be digitally printed on a surface to provide an easily recognizable and reflective metallic security feature. The combination of the reflective, metallic nature of the feature and the digital nature of the information printed by, e.g., ink-jet printing, can provide multiple levels of security to the substrate. The security provided by such features may be further enhanced by combining the printed metallic feature with other security features such as optically variable features, embossing, watermarks, threads, holograms, fluorescent substrates, as well as with other features of the metallic ink itself such as electrical conductivity and magnetism.

By way of non-limiting example, the above-described inks, e.g., ink jet inks or digital inks, can be printed in such a way as to produce a semi-transparent security feature in the visible region of the electromagnetic spectrum or visible spectrum. The semi-transparency of this feature enables multiple security features to be combined in unique combinations, one being visible through the other. The extent of optical semi-transparency compared to reflectivity of this feature can be adjusted according to the layer characteristics and the processing conditions. By way of example, a reflective semi-transparent feature can be printed over the surface of other overt features such as color images, black and white images, watermarks, holograms and the like, or combined with covert features such as, e.g., luminescent materials such as UV or anti-stokes phosphors as well as other covert features. The semi-transparent coating may also optionally be electronically conductive and/or magnetic, thereby adding an additional level of covert security to these features. A semi-transparent coating can also be created in a way that results in selective transparency in other regions of the electromagnetic spectrum such as, e.g., the ultraviolet and infrared regions.

In another non-limiting aspect, layers comprising different metallic particle and/or metallic nanoparticle compositions, e.g., inks, may be printed to achieve selective transparency according to the physical characteristics of the particle or nanoparticle metals printed. For example, by printing two different metallic particle and/or nanoparticle-containing inks over a color feature, optical transparency of a specific color is achievable. In addition, by printing two different metallic particle and/or nanoparticle containing inks a specific color is also achievable.

In another embodiment of the invention, multiple semitransparent layers may be formed, optionally printed (e.g., gravure printed, direct write printed, digitally printed and/or ink jet printed), which layers give rise to a metallic “flop” or color shift. In this embodiment, the security feature, e.g., reflective security feature, optionally comprises a first semitransparent layer and a second semitransparent layer disposed, at least in part, on top of the first semitransparent layer. Preferably, the first semitransparent layer has a thickness of from about 50 nm to about 500 nm, typically about 200 nm, and a lateral dimension that is significantly greater, e.g., on the order of at least several microns. The second semitransparent layer preferably has a thickness of from about 20 nm to about 500 nm and a lateral dimension that is significantly greater, e.g., on the order of at least several microns. The first semitransparent layer and/or the second semitransparent layer preferably comprises a metal oxide, e.g., mica, silica, titania, iron oxide, chromium oxide, or a mixture thereof, preferably mica, titania and/or silica. In a preferred embodiment, the first semitransparent layer and/or the second semitransparent layer comprise metallic particles and/or metallic nanoparticles, the metallic particles and/or metallic nanoparticles comprising a metal oxide. Specific preferred embodiments comprise various combinations of mica, titania and silica, as provided in Table 1, below:

TABLE 1
MULTI-LAYER SECURITY FEATURES

| First Layer | Second Layer |
|---|---|
| Mica | Titania |
| Titania | Mica |
| Silica | Mica |
| Mica | Silica |
| Silica | Titania |
| Titania | Silica |

Additionally, the security feature optionally comprises a third semitransparent layer disposed, at least in part, on top of the second semitransparent layer. The third semitransparent layer may have a thickness of from about 20 nm to about 500 nm and a lateral dimension that is significantly greater, e.g., on the order of at least several microns. The thicknesses of the second semitransparent layer and/or optional third semitransparent layer may be variable (e.g., having an increasing thickness in the x and/or y directions) to provide different metallic colors. Like the first and second semitransparent layers, the third semitransparent layer optionally comprises metallic particles and/or metallic nanoparticles, which preferably comprise a metal oxide, such as, but not limited to: mica, silica, titania, iron oxide, chromium oxide, or a mixture thereof, mica, silica and titania being particularly preferred. One or more of the first semitransparent layer, the second semitransparent layer and/or the optional third semitransparent layer may be formed by a printing process, e.g., a direct write printing process, preferably a digital printing process or an ink jet printing process. In this manner, security features comprising variable information advantageously may be created having unique metallic reflective effects. Table 2, below, provides a list of various semitransparent layers that may be used in combination with one another to create a security feature having specific metallic color characteristics. See Hugh M. Smith, High Performance Pigments, Wiley-VCH Verlag-GmbH, Weinheim, Germany, (2002), the entirety of which is incorporated herein by reference.

TABLE 2
MULTI-LAYER SECURITY FEATURES

| First Layer | Second Layer | Third Layer | Resulting Color(s)¹ |
|---|---|---|---|
| Mica | TiO₂ | — | Silver, Yellow, Red, |
| | | | Blue, Green |
| Mica | Fe₂O₃ | — | Bronze, Copper, |
| | | | Red, Red-Violet, |
| | | | Red-Green |
| Mica | Fe₂O₃ × TiO₂ | — | Gold |
| Mica | TiO₂ | Fe₂O₃ | Gold |
| Mica | TiO₂ | Iron Blue | Silver-Grey |
| Mica | TiO₂ | Cr₂O₃ | Green |

¹Multiple colors indicates that the color changes, in the order presented, as the thickness of the second reflective layer is increased.

In another embodiment, the first semitransparent layer and the third semitransparent layer are formed, at least in part, of the same composition, e.g., the same metal oxide. In this aspect, the second semitransparent layer preferably has a refractive index different from the first and third semitransparent layers so as to create a multiple interfaces leading to multiple interference effects giving rise to a “metal-effect” phenomenon. As a result, the layer structure of the security feature is constructed on the surface of the substrate by depositing the individual layers rather than by employing pre-fabricated multi-layer pigment particles that are subsequently applied to the substrate. This results in the ability to create novel security features that exhibit unusual color effects that cannot be created by depositing pre-fabricated multi-layer metal-effect pigment particles. Additional combinations of layers that form preferred multi-layer security features having unique metal effects are provided below in Table 3.

TABLE 3
MULTI-LAYER SECURITY FEATURES

| First Layer | Second Layer | Third Layer |
|---|---|---|
| Silica | Titania | Silica |
| Silica | Mica | Silica |
| Titania | Mica | Titania |
| Titania | Silica | Titania |
| Mica | Silica | Mica |
| Mica | Titania | Mica |

Thus, in one embodiment, the invention is to a security feature, comprising: (a) a first layer comprising first metallic particles, the first metallic particles comprising a first metal oxide; and (b) a second layer disposed at least in part on the first layer, the second layer comprising second metallic particles comprising a second metal oxide. Preferably, The security feature further comprises: (c) a third layer disposed at least in part on the second layer, the third layer comprising third metallic particles comprising the first metal oxide. Optionally, the first metal oxide is selected from the group consisting of silica, titania and mica, wherein the second metal oxide is selected from the group consisting of silica, titania and mica, and wherein the first metal oxide is different from the second metal oxide. In a preferred embodiment, the first metal oxide comprises titania and the second metal oxide comprises mica. This security feature preferably exhibits a color shift as it is tilted so as to provide an optical effect that is very difficult for a would-be counterfeiter to reproduces.

Additionally, although at least one of the semitransparent layers preferably is formed (e.g., direct write printed, digitally printed or ink jet printed), at least in part, from an ink comprising metallic particles and/or metallic nanoparticles, one or more of the reflective layers optionally may be formed from ink(s) comprising one or more of the pigment types identified in Table 4, below. These pigment types comprise particles that are generally too large to be printed through direct write, digital or ink jet printing processes.

TABLE 4
PIGMENT TYPES

| Pigment Type | Examples |
|---|---|
| Metallic platelets | Al, Zn/Cu, Cu, Ni, Au, Ag, Fe |
| | (steel), C (graphite) |
| Oxide coated metallic | Surface oxidized Cu—, Zn/Cu- |
| platelets | platelets, Fe₂O₃ coated Al- |
| | platelets |
| Coated mica platelets | Non-absorbing coating: TiO₂ |
| | (rutile), TiO₂ (anatase), ZrO₂, |
| | SnO₂, SiO₂; |
| | Selectively absorbing coating: |
| | FeOOH, Fe₂O₃, Cr₂O₃, TiO₂₋ₓ, |
| | TiOₓN_{y}, CrPO₄, KFe[Fe(CN)₆], |
| | colorants; |
| | Totally absorbing coating: |
| | Fe₃O₄, TiO, TiN, FeTiO₃, C, Ag, |
| | Au, Fe, Mo, Cr, W |
| Platelet-like | BiOCl, Pb(OH)₂ × 2 PbCO₃, α- |
| monocrystals | Fe₂O₃, α-Fe₂O₃ × n SiO₂, |
| | AlₓFe₂₋ₓO₃, Mn_{y}Fe_{2-y}O₃, |
| | AlₓMn_{y}Fe_{2-x-y}O₃, Fe₃O₄, reduced |
| | mixed phases, Cu-phthalocyanine |
| Comminuted thin | Al, Cr (semitransp.)/SiO₂/Al/ |
| PVD-films | SiO₂/Cr (semitransp.) |

A semi-transparent metallic particle coating or semi-transparent metallic nanoparticle coating according to the present invention may be achieved by a number of different methods. By way of non-limiting example, the digital resolution of a feature that is printed can be reduced to reduce the quantity of material printed on a substrate surface, resulting in an increase of the optical transparency by reducing the amount of surface area that is covered. Alternatively, the metallic particle or metallic nanoparticle-containing ink of the invention can be diluted to reduce the metallic particle or nanoparticle content, and printed to result in a thinner layer that fully covers the surface.

The optional treating, e.g., curing, step of the process for forming the security features, e.g., reflective security features, of the present invention (described above) may also have a strong influence on the level of transparency compared to its reflectivity. Usually, with a higher loading of metallic particles and/or metallic nanoparticles, a higher curing temperature and a longer curing time will contribute to higher reflectivity and lower optical transparency of printed feature. A lower curing temperature will usually lead to lower reflectivity, but increased transparency. Optimum conditions for achieving a combination of increased optical transparency and increased reflectivity usually include thinner layers of complete coverage of nanoparticles cured to give a more continuous film.

In one security application aspect of the present invention, the metallic particle and/or metallic nanoparticle-containing ink composition or formulation contains a coloring pigment and/or a dye such that when the ink composition or formulation is printed and, optionally treated (e.g., cured), the feature has a metallic luster, and in addition, the feature is of a color that is not characteristic of the metallic composition itself. By way of non-limiting example, a gold luster may be achieved by mixing a yellow dye with a silver nanoparticle ink.

In a further aspect, a fluorescent or phosphorescent additive may be incorporated in the ink, in which case a feature produced therefrom may have a combination of properties that include metallic luster (an overt feature) and luminescence (a covert feature) that can be detected by exposure to electromagnetic radiation of suitable wavelength, for example, by UV light of short (e.g., about 254 nm) or long (e.g., about 365 nm) wavelengths. In one such embodiment, a phosphor such as an IR absorbing phosphor (e.g., erbium and/or ytterbium doped yttrium borate) is utilized as described in U.S. Provisional Patent Application Ser. No. 60/731,004, filed Oct. 18, 2005, the entirety of which is incorporated herein by reference. In a further aspect, the pigment or dye may also be luminescent, resulting in a combination of characteristics where the printed security feature of the invention has a metallic luster, the color of which (in ordinary light) is determined by the nature of the pigment or dye, but under irradiation with, e.g., UV light, a visible light emission is observed.

In another security application aspect, metallic particle and/or metallic nanoparticle-containing ink compositions or formulations may be printed onto a substrate that is subsequently used to produce security threads. In this embodiment, the ink compositions or formulations may be printed, by any of the processes above, particularly direct write printing, onto, for example, paper or an organic polymer substrate together with a number of additional security features. The additional use of digital printing assists in providing variable information that creates an additional barrier to counterfeiting of the article to which the security feature is applied. In a typical application, the thread may be used to provide an added level of security to banknotes, paper documents such as passports, or teartape for opening consumer products such as bubble gum.

In yet another security application of the present invention, the printed security feature, preferably the printed reflective security feature of the invention, is used as part of a complex security feature that has unique optical characteristics such as an optically variable feature. By way of non-limiting example, the metallic particle and/or metallic nanoparticle-containing ink compositions or formulations of the present invention are used to print a metallic feature in a certain pattern that is highly reflective after curing. This reflective metallic feature (which, in this embodiment, preferably is fully reflective) can be used as the base layer in a series of printed layers to create an optical feature for a complex security feature. A second layer can be added over the surface of the reflective metallic layer, the second layer being optically transparent or semitransparent. A third layer may then be printed over the surface of the second layer such that it has the properties of being semi-transparent and reflective with respect to visible light. The third layer, in this embodiment, preferably absorbs a portion of the incoming light. A non-limiting example of this third layer is another coating of the metallic nanoparticle ink that is printed and cured in a way that provides for a very thin layer. In another non-limiting example, the first layer and/or the third layer comprises chromium or Inconel™ (a family of nickel-chromium-iron alloys). The effect exhibited by this three layer stack (sandwich) is an optical interference pattern between the light that is reflected by the top layer (the third layer) and the base layer (the first reflective metal ink layer), resulting in a unique color or colors as the article on which these layers are printed is tilted (changed in angle) with respect to the viewer. The optical variations that may be created by this kind of structure can be varied by the composition of the layers that comprise this structure and the thickness of the printed layers, in addition to the unique optical interference patterns created by the stack.

The material of the second (middle) layer of the sandwich can be almost any material that is optically transparent by virtue of either its inherent physical absorption spectrum and/or by the fact that it is comprised of particles with a size in the range that reduces light scattering. The material may be inorganic, organic (such as, e.g., an organic polymer) or a mixture of both. Materials with high refractive index such as, e.g., TiO₂, silica, or MgF₂, provide for enhanced effects. The material may also have some other functional characteristics such as be comprised of luminescent particles such that the feature has a combination of overt and covert properties.

In this embodiment, the various layers used to form the security feature may be formed by the same or different printing process. For example, the first layer optionally is formed by a printing process selected from the group consisting of direct write printing (e.g., ink jet or digital printing), intaglio printing, gravure printing, offset printing, lithographic printing and flexographic printing processes. Optionally, the second layer is formed by a printing process selected from the group consisting of direct write printing (e.g., ink jet or digital printing), intaglio printing, gravure printing, offset printing, lithographic printing and flexographic printing processes. Similarly, the third layer optionally is formed by a printing process selected from the group consisting of direct write printing (e.g., ink jet or digital printing), intaglio printing, gravure printing, offset printing, lithographic printing and flexographic printing processes. Thus, one, two or all of the three layers may be formed by a direct write printing process, such as a digital printing process or an ink jet printing process. In other embodiments, more than three layers are employed to provide an even further unique security feature.

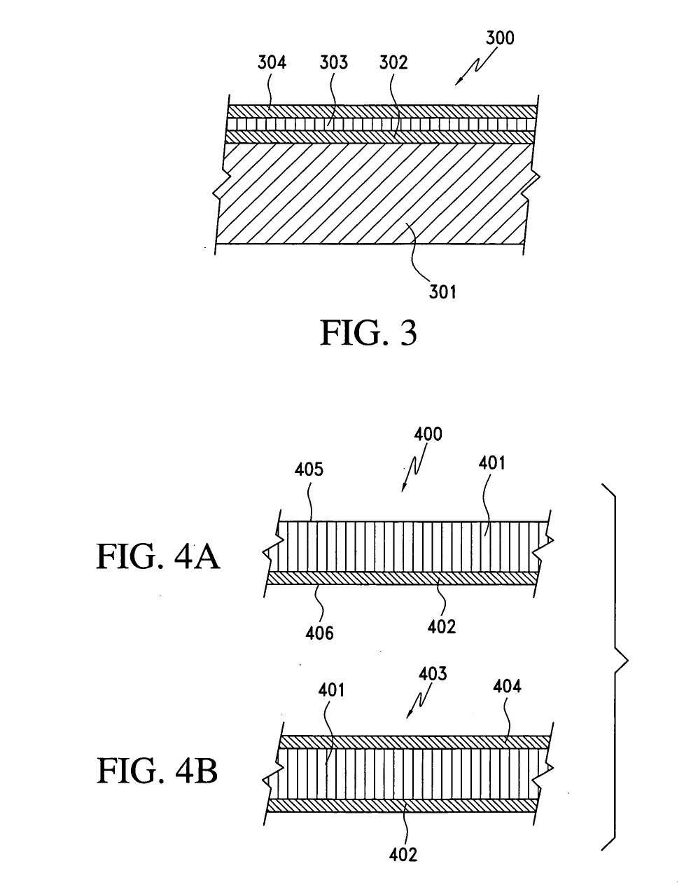

FIG. 3 illustrates a non-limiting security feature 300 according to this aspect of the invention. As shown, security feature 300 includes a three-layer structure on substrate 301. The three-layer structure includes a first reflective layer 302 disposed on substrate 301. The first reflective layer 302 may be semitransparent or opaque. A translucent layer 303 is disposed on the first reflective layer 302. The transparent layer 303 may comprise an inorganic composition, an organic composition (such as, e.g., an organic polymer) or a mixture of both. The transparent layer 303, for example, optionally comprises one or more of TiO₂, silica, and/or MgF₂. A second reflective layer 304, which preferably is semitransparent, is disposed on the translucent layer 303, as shown. The first reflective layer 302 and the second reflective layer 304 may be formed of the same material or different materials. Preferably, the second reflective layer is formed from an ink, preferably a direct write ink such as an ink jet ink or a digital ink comprising metallic particles and/or metallic nanoparticles. The first reflective layer optionally is also formed from this ink. This security feature 403 provides a unique optical characteristic, such as an optically variable feature, which is very difficult for counterfeiters to reproduce.

In a related aspect, the security feature, preferably reflective security feature, optionally is printed, e.g., through a direct write printing process such as ink jet printing, onto a substrate comprising a sheet of a transparent material (optionally, a polymer) having a thin reflective layer disposed thereon in order to form a complex security feature, similar to the one described above, but in a single printing step. In this aspect, the substrate has a transparent surface and an opposing reflective surface that may be semitransparent or opaque. A security feature (e.g., reflective layer) is printed, e.g., through a direct write printing process such as ink jet printing or digital printing, directly onto the transparent surface to form a three-layer complex security feature, similar to the three-layer security feature described above. The printed layer may similarly be semitransparent (e.g., if the reflective surface on the substrate is opaque) or opaque (e.g., if the reflective surface on the substrate is semitransparent). Thus, in another embodiment the security feature of the invention is disposed on (or printed onto) a substrate comprising a sheet of transparent material and a reflective layer, the transparent material having a transparent surface, and the security feature being disposed on (or printed onto) the transparent surface. This process for forming a three-layer complex security feature requires only a single printing step and is, accordingly, simpler than separately printing all three layers. The resulting three-layer security feature may then be secured to a commercial article through any conventional attachment means, e.g., adhesive.

This embodiment is illustrated in FIGS. 4A-B. FIG. 4A illustrates a substrate 400 comprising an optically transparent layer 401. The transparent layer 401 may comprise an inorganic composition, an organic composition (such as, e.g., an organic polymer) or a mixture of both. The transparent layer 401, for example, optionally comprises one or more of TiO₂, silica, and/or MgF₂. Substrate 400 also comprises a first reflective layer 402 disposed on the transparent layer 401, as shown. Optionally, the first reflective layer is semitransparent. Alternatively, the first reflective layer is opaque. As shown, substrate 400 has a transparent surface 405 and an opposing reflective surface 406. As discussed above, an ink, preferably a direct write ink such as an ink jet ink or a digital ink comprising metallic particles and/or metallic nanoparticles, is printed onto the transparent surface 405 of substrate 400 and optionally treated to form a second reflective layer 404 thereon and form three-layer security feature 403, shown in FIG. 4B. Security feature 403, like security feature 300 shown in FIG. 3, provides a unique optical characteristic, such as an optically variable feature, which is very difficult for counterfeiters to reproduce.

A printed security feature, e.g., reflective security feature, made from the inks and by the processes of the present invention can be combined with other security features to create additional levels of security. The additional security features may be overt or covert. Non-limiting examples of additional overt features include optically variable features, holograms, embossing, water marks and the like. Non-limiting examples of additional covert features include luminescent materials such as UV excitable phosphors, up-conversion phosphors, microprint or microimages. Additionally or alternatively, the security feature may posses magnetic characteristics, optionally in combination with an optical effect. For example, the security feature may posses a magnetic characteristic (which may serve as a covert security feature) as well as exhibit an optical effect (which may serve as an overt and/or a covert security feature). This may be the case, for example, if the security feature comprises metallic particles that comprise iron oxide.

As indicated above, in a preferred embodiment, the invention is to a security feature or part of a complex security feature, preferably where the security feature or the part of the complex security feature is reflective, where the security feature or the part of the complex security feature comprises metallic particles, preferably metallic nanoparticles. In another aspect, the invention is to a digitally-printed security feature, preferably a digitally-printed reflective security feature, which optionally comprises metallic particles, preferably metallic nanoparticles. In either case, the security feature optionally is disposed on a substrate surface having an image thereon. The security feature preferably overlaps at least a portion of the image. In this aspect, the term “security feature” may be used to refer exclusively to the reflective layer that overlaps the image or the combination of the reflective layer and the underlying image. In a most preferred embodiment, the security feature of the invention comprises variable information printed, created or formed from the ink compositions of the invention, the ink compositions comprising metallic particles and/or metallic nanoparticles.

In a related embodiment, the invention relates to a security feature, comprising: (a) a substrate having a surface comprising an image; and (b) a reflective layer comprising metallic particles and/or metallic nanoparticles disposed on at least a portion of the surface and at least partially overlapping the image.

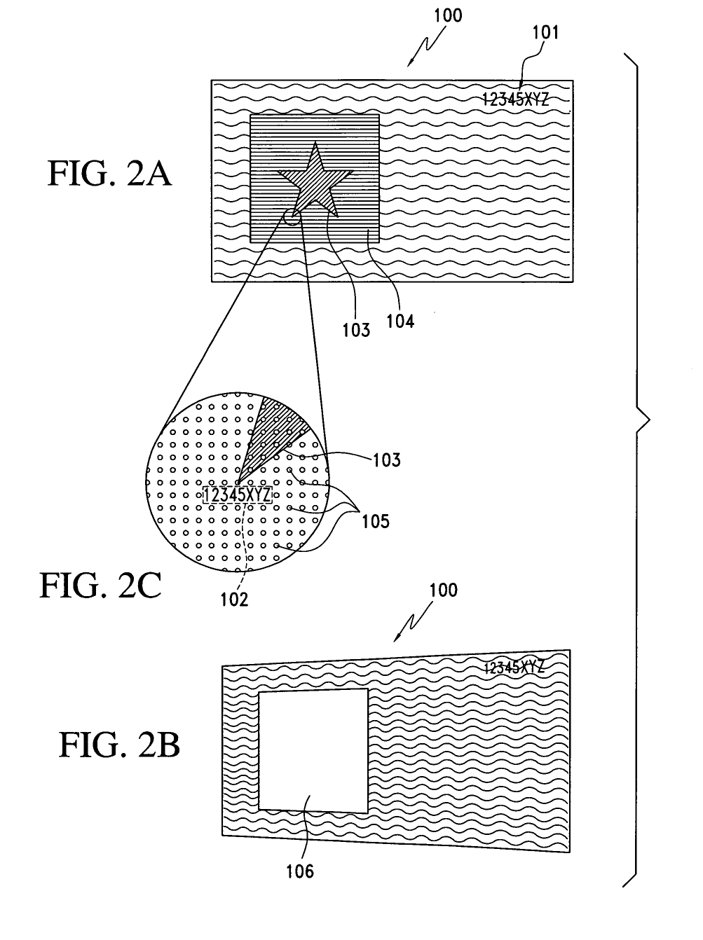

In a preferred aspect, for example, the security feature comprises a semitransparent reflective layer, comprised of metallic particles, preferably metallic nanoparticles, which feature overlaps at least a portion of, preferably the entirety of, an underlying image and provides angle dependent reflectivity. The nature of the reflective layer causes the image to be viewable therethrough when the feature is viewed at a first angle relative to the substrate surface. When viewed at a second angle, however, the underlying image becomes at least partially obscured as incident light is reflected off of the semitransparent reflective layer towards the observer's eye. The feature in which an image underneath the security feature may be obscured at one or more angles is referred to herein as a “photo-obscuring” effect. For example, the second angle preferably is about 180° minus the angle of incident light, relative to the substrate surface. This photo-obscuring effect, described in more detail above, is particularly difficult for a would-be counterfeiter to reproduce. While not being bound by any particular theory, this effect may be derived from the fact that at certain angles the reflective security feature behaves like a mirror and reflects light from an incident light source directly toward an observer. The brightness from this reflected light substantially obscures the underlying image from view (as shown in FIG. 2B, discussed below). At other angles, however, the reflective feature does not reflect the incident light toward the viewer, and the underlying image may be clearly viewed by the observer.

In one aspect, the security feature comprises a reflective layer comprising metallic particles and/or nanoparticles that is non-continuous. As used herein, the term “non-continuous” means formed, at least in part, of a plurality of separate disconnected objects wherein the average distance between adjacent objects is less than about 500 μm, or formed, at least in part, of a single object having at least one space or gap therein, e.g., a spiral pattern, the space or gap having a width less than about 500 μm. In a preferred embodiment, the non-continuous reflective layer comprises a plurality of reflective images, preferably a plurality of reflective microimages, which provide an additional covert security element.

One purpose of the gaps or spaces in a non-continuous semitransparent reflective layer is to permit an observer, at a first angle, to view an image that is underneath the semitransparent reflective layer. At a second angle, however, incident light should reflect off of the metallic particles and/or metallic nanoparticles in the semitransparent reflective layer and thereby obscure the underlying image from the observer. In order for the gaps or spaces to accomplish this purpose, the average minimum dimension of the gaps or spaces should be relatively small. For example, the average minimum dimension of the gaps or spaces optionally is less than about 500 μm, e.g., less than about 250 μm, less than about 100 μm, or less than about 50 μm.

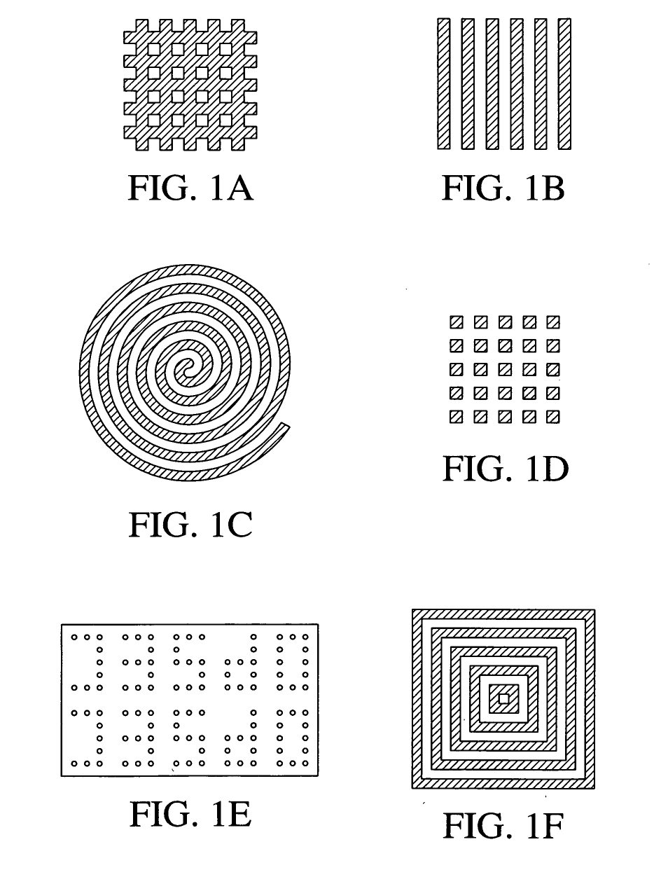

A non-continuous semitransparent reflective layer may be formed by printing a reflective layer comprising metallic particles and/or metallic nanoparticles in a pattern having openings or gaps, which permit light to pass through the reflective layer, at least when viewed at a first angle. The openings or gaps may take a variety of forms. For example, the reflective layer may comprise a cross-hatching pattern (as shown in FIG. 1A), resembling a window screen pattern. In another embodiment, the reflective layer comprises a plurality of parallel lines, as shown in FIG. 1B, where the lines are created, formed, deposited, printed using the ink composition comprising metallic particles and/or metallic nanoparticles of the invention. The lines can advantageously have an average width of not greater than about 250 μm, such as not greater than about 200 μm, not greater than about 150 μm, not greater than about 100 μm, or not greater than about 50 μm. Although FIG. 1B illustrates straight lines, the lines in the security feature may be straight, curved, sinusoidal, overlapping, zigzagged, or a combination thereof. The ends of the lines may or may not be connected to an adjacent line (they are shown unconnected in FIG. 1B). In another aspect, the reflective layer may be a spiral pattern, as shown in FIG. 1C. In another aspect, the reflective layer comprises a plurality of dots, as shown in FIG. 1D. In another embodiment, the reflective layer comprises a plurality of text objects, e.g., alphanumeric objects, which optionally are formed from a plurality of dots, as shown in FIG. 1E. In another aspect, the reflective layer comprises a plurality of geometric shapes of similar shape, but of different size, each shape situated within the next larger sized shape, as shown in FIG. 1F. The shapes may include squares, circles, ovals, rectangles, stars, or any other shape. These shapes may, or may not, overlap an adjacent shape, so long as spaces or gaps remain in the reflective layer sufficient to view the underlying latent image. In another aspect, one or more of these embodiments may be combined. These are but a few non-limiting exemplary embodiments in which the security feature comprises a semi-transparent reflective layer, and one in the art will recognize that a semi-transparent reflective layer having gaps or openings therein may be formed of infinite other patterns, e.g., repeating or non-repeating characters, text, letters, numbers, stars, circles, squares, images, etc. Other exemplary shapes and patterns are described in Published PCT Application No. WO 2005/080089 A1, which published on Sep. 1, 2005, the entirety of which is incorporated herein by reference.

FIGS. 2A-C presents a non-limiting example of a security feature 100 according to one embodiment of the present invention. The security feature illustrated displays the above-described photo-obscuring effect. FIG. 2A is an illustration of security feature 100 observed from a first angle relative to the substrate surface. At the first angle shown, an overt image 103 comprising a star is clearly visible through a semitransparent reflective layer 104, which overlaps the star image 103. At a second angle, shown in FIG. 2B, however, incident light is reflected off of the semitransparent reflective layer 104 toward the observer thereby substantially obscuring the image 103, as shown by obscured region 106 (in which the image 103 shown in FIG. 2A is not visible).

In the security feature 100 shown in FIGS. 2A-B, the semi-transparent reflective layer 104 comprises a plurality of reflective microimages 105. The microimages 105 are not visible in FIGS. 2A-B, but are shown in magnified inset FIG. 2C. As used herein, the term “microimage” means a substantially two-dimensional abstract or geometric shape, or a symbolic representation of an object or information having a largest average dimension less than 0.5 mm, e.g., less than about 0.4 mm, less than about 0.3 mm or less than about 0.2 mm, less than about 0.1 mm, less than about 750 μm, less than about 500 μm or less than about 250 μm. The distance between adjacent microimages 105 forms the spaces or gaps described above in reference to FIGS. 1A-E. As shown in inset FIG. 2C, the microimages 105 in the security feature 100 of FIGS. 2A-B comprise repeating circles. In another preferred aspect, the microimages comprise a sequence of alphanumeric text.

In one embodiment of the present invention, the security feature, e.g., reflective security feature, comprises at least one microimage that comprises variable information. Thus, in one aspect, the security feature comprises a reflective layer comprising a plurality of microimages, at least one of the microimages optionally comprising variable information, and wherein, preferably the micorimages are created, formed, deposited printed using ink compositions comprising metallic particles and/or nanoparticles of the invention. As an added security element, the security feature optionally includes overt variable information, which may or may not be formed from the metallic nanoparticles discussed above. In one particularly desirable aspect of the invention, the security feature comprises overt and covert variable information, where the overt and covert variable information display the same information, or information that may be correlated with one another (e.g., by a mathematical formula or other means).

FIGS. 2A-C illustrate this aspect of the invention. As shown, the security feature 100 includes overt variable information 101, which is readily visible with the naked eye. This same variable information is also displayed at least once in the microimages 105 of the semitransparent reflective layer 104, as shown by covert variable information 102. Thus, as an added security element, one can examine the covert variable information 102 with a loop or other simple magnification device, compare the overt variable information 101 with the covert variable information 102, and ensure that they match one another or may be otherwise correlated with one another.

In one embodiment, the microprint of alphanumeric characters or optical recognition characters or symbols, images or the like, are printed, created, formed, or deposited using the ink compositions or formulation of the invention comprising the metallic particles and/or nanoparticles of the invention. In a preferred embodiment, the microprint characters, images, symbol, and the like are modified to increase the dot per square inch or density of the print. This is accomplished by essentially creating a new font in which the number of dots making up the individual characters is reduced such that the basic information, visible image, or value of the character remains unchanged. For example, the number “2” in Times New Roman at 2 point font size is comprised of 33 dots, and for this embodiment of the invention, 20 dots are removed without losing the basic information, visible image or value of the character “2”. This technique provides for the ability to microprint various security features such as variable information using the ink composition or formulations of the invention with better resolution and visual effect such as semi-transparency.

In another aspect, the security feature comprises a continuous semi-transparent reflective, and the continuous semi-transparent reflective layer comprises the metallic particles and/or metallic nanoparticles of the invention. As used herein, the term “continuous” means formed of a single, discreet, connected object, e.g., ink, substantially free of gaps.

The continuous reflective layer may be translucent or opaque. As used herein, the term “translucent” means capable of allowing light to pass therethrough, but not exclusively through spaces or gaps (although some spaces and gaps may or may not be present in a translucent layer). In this aspect, the translucent reflective layer preferably is particularly thin, e.g., on the order of less than about 5 μm, less than about 1 μm, less than about 500 nm or less than about 50 nm, in order to allow light to pass through the semitransparent reflective layer.

The translucent reflective layer may present a photo-obscuring effect similar to the photo-obscuring effect created with a non-continuous reflect layer, discussed above with reference to FIGS. 2A-C. That is, the translucent reflective layer may be disposed on an image on the substrate surface. The image may be viewable through the translucent reflective layer at a first angle relative to the substrate surface, but obscured at a second angle relative to the substrate surface as incident light is reflected off the translucent reflective layer towards the observer.

In another embodiment, the security feature comprises a reflective layer disposed on at least a portion of an underlying image having a longitudinally varying topography, described above. If the image(s) do have a longitudinally varying topography, the security feature (or the reflective layer thereof) printed on at least a portion of the image preferably presents a translation of the longitudinally varying topography of the overlapped image. It has been found that the reflective security features of the present invention, when formed on an underlying image having longitudinally varying topography, provide a security element that is very difficult to reproduce. In this embodiment, the reflective layer displays a likeness of the underlying image, even if the reflective layer is opaque, since the longitudinally varying topography of the underlying image is translated to the overlapping reflective layer.

Thus, in one aspect, the continuous reflective layer at least partially overlaps an image on a substrate surface, the image having a longitudinally varying topography, and the continuous reflective layer presents a translation of the longitudinally varying topography of the overlapped image. In this embodiment, the reflective layer may be continuous or non-continuous. If continuous, the reflective layer in this embodiment may be translucent or opaque. That is, the reflective layer may provide a translation of the underlying image, even if the reflective layer is opaque and the underlying image is not actually visible through the reflective layer.

In one aspect, the average thickness of the security feature comprising the metallic particles or metallic nanoparticles, or the security feature created, formed, deposited or printed from an ink comprising the metallic particles and/or metallic nanoparticles, may be greater than about 0.01 μm, e.g., greater than about 0.05 μm, greater than about 0.1 μm, or greater than about 0.5 μm. The thickness can even be greater than about 1 μm, such as greater than about 5 μm. These thicknesses can be obtained by direct write deposition, for example by ink-jet deposition or deposition of discrete units of material in a single pass or in two or more passes. For example, a single layer can be deposited and dried, followed by one or more repetitions of this cycle, if desired. Optionally, the thickness of the deposited security feature, e.g., of the reflective layer (optionally an opaque, semitransparent, continuous or non-continuous reflective layer), is less than about 2 μm, less than about 1 μm, less than about 750 nm, or less than about 500 nm.

The distance between the metallic particles and/or metallic nanoparticles in the security feature, e.g., reflective security feature or reflective layer thereof, may vary widely. In various embodiments, the average distance between adjacent metallic particles and/or metallic nanoparticles in the security feature (e.g., reflective security feature or reflective layer thereof) is less than about 1 μm, e.g., less than about 700 nm, less than about 500 nm, less than about 250 nm, less than about 100 nm or less than about 50 nm.

In another security application aspect of the present invention, the security feature, optionally reflective security feature, comprises a conductive (optionally reflective) layer or trace that provides an additional security element in an article. In this aspect, the security feature comprises metallic particles and/or metallic nanoparticles and exhibits a conductivity authentication feature. By way of non-limiting example, as described above, a printed metallic security feature may be cured under conditions that result in electrical conductivity, e.g., through necking of adjacent metallic nanoparticles, thus providing an additional level of security. The presence of electrical conductivity can be determined, for example, by a contact method such as, e.g., 2-point or 4-point probe measurements, or by contact-less methods in which the presence of a conductive feature is determined in an electric or magnetic field. For example, the printed metallic feature can be constructed with dimensions (thickness, width and length) in which the electrical conductivity of the feature may vary as a function of the position within the feature where the measurement is made. This provides for an additional level of security in this feature. In one embodiment, a majority (e.g., at least about 60 weight percent, at least about 75 weight percent, at least about 80 weight percent or at least about 90 weight percent) of the metallic particles and/or metallic nanoparticles in the security feature are necked with at least one adjacent nanoparticle.

Thus, the security feature itself or portions or components of the security feature, preferably a reflective security feature, optionally are conductive. In a preferred embodiment, the security feature comprises metallic particles and/or metallic nanoparticles, the metallic particles and/or metallic nanoparticles comprising a bulk metal. At least a portion, portions, or all of the security feature or components of the security feature, preferably a reflective security feature, comprising metallic particles and/or metallic nanoparticles, have a resistivity that is not higher than about 30 times, e.g., not higher than about 20 times, not higher than about 10 times, or not higher than about 5 times the resistivity of pure bulk metal(s) of the metallic particles and/or metallic nanoparticles. Thus, in one embodiment, the security features of the inventions are conductive, or portions of the security features are conductive. Preferably, the security features of the invention or portions of the security features of the invention are both reflective and comprise conductive portions. Combining reflective and conductive security characteristics further enhances the security of the security feature, whether it is a tag, label, banknote, document, etc. Not only would a counterfeiter have to duplicate the reflective nature of the security feature of the invention but also the conductivity. In still yet another embodiment, the security feature or a portion thereof further includes a magnetic property in combination with reflectivity and/or conductivity. In another aspect, a portion of the security feature, e.g., the reflective security feature comprising the metallic particle and/or metallic nanoparticles, has a high conductivity (low resistivity) although the entire security feature exhibits little or no conductivity. That is, in one aspect, the invention is to a substantially non-conductive security feature comprising conductive portions or components. The conductive portions optionally have a minimum feature size of less than about 1 cm, e.g., less than about 500 μm, less than about 250 μm, less than about 100 μm, or less than about 50 μm. In terms of ranges, the conductive portions optionally have a minimum feature size of from about 10 μm to about 5 cm, e.g., from about 250 μm to about 5 cm, from about 500 μm to about 3 cm, or from about 750 μm to about 2 cm. In this aspect, the region of high conductivity preferably has a resistivity that is less than about 30 times the resistivity of the bulk metal, e.g., less than about 10 times the resistivity of the bulk metal, or less than about 5 times the resistivity of the bulk metal. The entire security feature, however, optionally exhibits a resistivity greater than at least 10 times the resistivity of the bulk metal of the metallic particles and/or nanoparticles, e.g., at least 30 times, at least 50 times, at least about 100 times, at least about 500 times or at least about 1000 times the resistivity of the bulk metal. Further, the conductivity of the entire security feature optionally is greater than about 10 times less than the conductivity of the conductive portion, e.g., greater than about 100 times less or greater than about 1000 times less than the conductivity of the conductive portion. In one embodiment, the security feature comprises two or more types of variable information, e.g., one type that is visually recognizable in the security feature (such as a serial number), and another that is variable resistivity of component features. This provides for two levels of security in the feature: overt security (the variable characters) and covert security (the variable resistance of the subcomponents).

In another embodiment, the invention is to a substantially non-conductive UV curable security feature comprising conductive portions or components, wherein the security feature is free of a UV curable organic composition, e.g., free of an organic UV curable vehicle, monomer or polymer. In this embodiment, the conductive portions or components comprise metallic particles and/or nanoparticles that preferably further comprise an anti-agglomeration substance, for example a polymer, preferably a polymer containing a heteroatom.

### EXAMPLE

An ink comprising silver nanoparticles (average particle size 50 nm, 5 wt %), ethylene glycol (EG) (38 wt %), diethylene glycol monoethyl ether (DEGME) (38 wt %), and glycerol (19 wt %) was prepared through the dispersion of silver nanoparticles into a 40:40:20 mixture of EG:DEGME:Glycerol. This ink had a viscosity of 21.8 cP at 25° C. (100 RPM), and a surface tension of 37 mN/m. This ink was jetted from a SE128 piezoelectric Spectra inkjet printhead, available from Dimatix Inc., while the ink reservoir was kept at 40° C. The ink was jetted continuously on a substrate to form reflective security features for one hour with no interruption at 12 kHz. The ink was also jetted on a web system at speeds of (speed of substrate moving below the head) 100 ft/min, 200 ft/min, and 300 ft/min at resolutions of 300 dpi and 500 dpi. After jetting with on and off times for about 8 hours it was observed that all jets were firing and no capping/clogging negatively affected inkjet performance. The printed reflective security features were extremely reflective as observed by the naked eye.

While the present invention has been described with reference to exemplary embodiments, it is understood that the words that have been used are words of description and illustration, rather than words of limitation. Changes may be made, within the purview of the appended claims, as presently stated and as amended, without departing from the scope and spirit of the present invention in its aspects. Although the invention has been described herein with reference to particular means, materials and embodiments, the invention is not intended to be limited to the particulars disclosed herein. Instead, the invention extends to all functionally equivalent structures, methods and uses, such as are within the scope of the appended claims.

We claim:

1. A reflective security feature comprising metallic particles.

2. The reflective security feature of claim 1, wherein the metallic particles have an average particle size of less than about 5 μm.

3. The reflective security feature of claim 1, wherein the reflective security feature comprises metallic nanoparticles.

4. The reflective security feature of claim 1, wherein the metallic particles have an average particle size of less than about 1 μm.

5. The reflective security feature of claim 4, wherein the metallic particles have an average particle size of less than about 500 nm.

6. The reflective security feature of claim 5, wherein the metallic particles have an average particle size of less than about 100 nm.

7. The reflective security feature of claim 1, wherein the metallic particles have an average particle size of from about 50 nm to about 100 nm.

8. The reflective security feature of claim 1, wherein the reflective security feature at least partially overlaps an image on a substrate surface.

9. The reflective security feature of claim 8, wherein at least a portion of the image is viewable through the reflective security feature when viewed at a first angle relative to the substrate surface, and wherein the at least a portion of the image is at least partially obscured when viewed from a second angle relative to the substrate surface.

10. The reflective security feature of claim 1, wherein the reflective security feature is made by a process which comprises ink-jet printing an ink comprising the metallic particles onto a substrate.

11. The reflective security feature of claim 1, wherein the reflective security feature is luminescent.

12. The reflective security feature of claim 1, wherein at least a portion of the reflective security feature displays variable information.

13. The reflective security feature of claim 1, wherein the reflective security feature is disposed on a substrate comprising a sheet of transparent material and a reflective layer, the transparent material having a transparent surface, and the reflective security feature being disposed on the transparent surface.

14. The reflective security feature of claim 13, wherein the reflective security feature exhibits an optical interference pattern.

15. The reflective security feature of claim 1, wherein the metallic particles comprise a metal selected from the group consisting of silver, gold, zinc, tin, copper, platinum and palladium or a combination thereof.

16. The reflective security feature of claim 1, wherein the average distance between adjacent metallic particles is less than about 700 nm.

17. The reflective security feature of claim 16, wherein a majority of the metallic particles are necked with at least one adjacent nanoparticle.

18. The reflective security feature of claim 1, wherein the reflective security feature comprises a reflective layer that is at least partially semitransparent.

19. The reflective security feature of claim 18, wherein the reflective layer comprises a non-continuous reflective layer, the non-continuous reflective layer comprising the metallic particles.

20. The reflective security feature of claim 18, wherein the reflective layer comprises a plurality of microimages, at least one of the microimages optionally comprising variable information.

21. The reflective security feature of claim 20, wherein the plurality of microimages has an average largest dimension of less than about 0.5 mm.

22. The reflective security feature of claim 18, wherein the reflective layer comprises a continuous reflective layer, the continuous reflective layer comprising the metallic particles.

23. The reflective security feature of claim 22, wherein the continuous reflective layer is translucent.

24. The reflective security feature of claim 22, wherein the continuous reflective layer is opaque.

25. The reflective security feature of claim 22, wherein the continuous reflective layer at least partially overlaps an image on a substrate surface, the image having a longitudinally varying topography.

26. The reflective security feature of claim 25, wherein the continuous reflective layer presents a translation of the longitudinally varying topography of the overlapped image

27. A banknote comprising the reflective security feature of claim 1.

28. A brand authentication tag comprising the reflective security feature of claim 1.

29. An article of manufacture comprising the brand authentication tag of claim 28.

30. A tax stamp comprising the reflective security feature of claim 1.

31. An alcohol bottle comprising the tax stamp of claim 30.

32. A tobacco product container comprising the tax stamp of claim 30.

33. A digitally-printed reflective security feature.

34. The reflective security feature of claim 33, wherein the digitally-printed reflective security feature comprises metallic particles.

35. The reflective security feature of claim 34, wherein the metallic particles have an average particle size of less than about 5 μm.

36. The reflective security feature of claim 34, wherein the metallic particles comprise a metal selected from the group consisting of silver, gold, zinc, tin, copper, platinum and palladium or a combination thereof.

37. The reflective security feature of claim 34, wherein the average distance between adjacent metallic particles is less than about 700 nm.

38. The reflective security feature of claim 37, wherein a majority of the metallic particles are necked with at least one adjacent nanoparticle.

39. The reflective security feature of claim 33, wherein the digitally-printed reflective security feature at least partially overlaps an image on a substrate surface.

40. The reflective security feature of claim 39, wherein at least a portion of the image is viewable through the digitally-printed reflective security feature when viewed at a first angle relative to the substrate surface, and wherein the at least a portion of the image is at least partially obscured when viewed from a second angle relative to the substrate surface.

41. The reflective security feature of claim 33, wherein at least a portion of the digitally-printed reflective security feature displays variable information.

42. The reflective security feature of claim 33, wherein the digitally-printed reflective security feature is disposed on a substrate comprising a sheet of transparent material and a reflective layer, the transparent material having a transparent surface, and the digitally-printed reflective security feature being disposed on the transparent surface.

43. The reflective security feature of claim 42, wherein the reflective security feature exhibits an optical interference pattern.

44. The reflective security feature of claim 33, wherein the digitally-printed reflective security feature comprises a reflective layer that is at least partially semitransparent.

45. The reflective security feature of claim 44, wherein the reflective layer comprises a non-continuous reflective layer, the non-continuous reflective layer comprising metallic particles.

46. The reflective security feature of claim 45, wherein the reflective layer comprises a plurality of microimages, at least one of the microimages optionally comprising variable information.

47. The reflective security feature of claim 46, wherein the plurality of microimages has an average largest dimension of less than about 0.5 mm.

48. The reflective security feature of claim 44, wherein the reflective layer comprises a continuous reflective layer, the continuous reflective layer comprising metallic particles.

49. The reflective security feature of claim 48, wherein the continuous reflective layer is translucent.

50. The reflective security feature of claim 48, wherein the continuous reflective layer is opaque.

51. The reflective security feature of claim 48, wherein the continuous reflective layer at least partially overlaps an image on a substrate surface, the image having a longitudinally varying topography.

52. The reflective security feature of claim 51, wherein the continuous reflective layer presents a translation of the longitudinally varying topography of the overlapped image

53. A banknote comprising the reflective security feature of claim 33.

54. A brand authentication tag comprising the reflective security feature of claim 33.

55. An article of manufacture comprising the brand authentication tag of claim 54.

56. A tax stamp comprising the reflective security feature of claim 33.

57. An alcohol bottle comprising the tax stamp of claim 56.

58. A tobacco product container comprising the tax stamp of claim 56.

59. A security feature, comprising:
(a) a substrate having a surface, the surface comprising an image; and
(b) a reflective layer comprising metallic particles disposed on at least a portion of the surface and at least partially overlapping the image.

60. The security feature of claim 59, wherein the metallic particles have an average particle size of less than about 5 μm.

61. The security feature of claim 59, wherein the security feature comprises metallic nanoparticles.

62. The security feature of claim 59, wherein the metallic particles have an average particle size of less than about 1 μm.

63. The security feature of claim 62, wherein the metallic particles have an average particle size of less than about 500 nm.

64. The security feature of claim 63, wherein the metallic particles have an average particle size of less than about 100 nm.

65. The security feature of claim 59, wherein the metallic particles have an average particle size of from about 50 nm to about 100 nm.

66. The security feature of claim 59, wherein the reflective layer is at least partially semitransparent.

67. The security feature of claim 66, wherein the reflective layer comprises a non-continuous reflective layer.

68. The security feature of claim 67, wherein at least a portion of the image is viewable through the reflective layer when viewed at a first angle relative to the surface, and wherein the at least a portion of the image is at least partially obscured when viewed from a second angle relative to the surface.

69. The security feature of claim 68, wherein the second angle is about 180° minus the angle of incident light, relative to the surface.

70. The security feature of claim 68, wherein the reflective layer comprises a plurality of reflective images.

71. The security feature of claim 70, wherein the reflective layer comprises a plurality of reflective microimages, wherein the plurality of reflective microimages has an average largest dimension of less than about 0.5 mm.

72. The security feature of claim 71, wherein at least one microimage comprises variable data.

73. The security feature of claim 59, wherein the image is formed from a printing process selected from the group consisting of direct write printing, intaglio printing, gravure printing, lithographic printing and flexographic printing processes.

74. The security feature of claim 59, wherein the image is selected from the group consisting of a hologram, a black and white image, a color image, a watermark, a UV fluorescent image, text and a serial number.

75. The security feature of claim 59, wherein the metallic particles comprise a metal selected from the group consisting of silver, gold, zinc, tin, copper, platinum and palladium or a combination thereof.

76. The security feature of claim 59, wherein the average distance between adjacent metallic particles is less than about 700 nm.

77. The security feature of claim 76, wherein a majority of the metallic particles are necked with at least one adjacent nanoparticle.

78. The security feature of claim 59, wherein the reflective layer comprises a continuous reflective layer.

79. The security feature of claim 78, wherein at least a portion of the image is viewable through the continuous reflective layer when viewed at a first angle relative to the surface, and wherein the at least a portion of the image is at least partially obscured when viewed from a second angle relative to the surface.

80. The security feature of claim 79, wherein the second angle is about 180° minus the angle of incident light, relative to the surface.

81. The security feature of claim 78, wherein the continuous reflective layer is translucent.

82. The security feature of claim 78, wherein the continuous reflective layer is opaque.

83. The security feature of claim 78, wherein image has a longitudinally varying topography.

84. The security feature of claim 83, wherein the continuous reflective layer presents a translation of the longitudinally varying topography of the overlapped image

85. A process for forming a reflective security feature, the process comprising the steps of:
(a) providing an ink comprising metallic particles; and
(b) direct write printing the ink to form the reflective security feature.

86. The process of claim 85, wherein at least a portion of the reflective security feature displays variable information.

87. The process of claim 86, wherein the variable information comprises covert information and/or overt information.

88. The process of claim 85, wherein the reflective security feature is formed at a rate greater than about 15 m/s.

89. The process of claim 85, wherein step (b) occurs continuously at a substantially constant temperature.

90. The process of claim 85, wherein step (b) comprises ink jet printing the ink from an ink reservoir, through a print head, and onto a substrate, wherein the temperature of the ink reservoir or print head is greater than about 30° C.

91. The process of claim 85, wherein the process further comprises the step of:
(c) applying ultraviolet or infrared radiation to the printed ink.

92. The process of claim 85, wherein the ink comprises a non-UV-curable vehicle, and wherein the process further comprises the step of:
(c) applying ultraviolet radiation to the printed ink.

93. The process of claim 85, wherein the reflective security feature is at least partially semitransparent.

94. The process of claim 85, wherein the reflective security feature is printed on a substrate comprising a sheet of transparent material and a reflective layer, the transparent material having a transparent surface, and the reflective security feature being printed on the transparent surface.

95. The process of claim 94, wherein the reflective security feature exhibits an optical interference pattern.

96. The process of claim 85, wherein the reflective security feature comprises a non-continuous reflective layer.

97. The process of claim 96, wherein the reflective security feature comprises a plurality of reflective microimages, wherein at least one microimage optionally comprises variable data.

98. The process of claim 85, wherein the metallic particles comprise a metal selected from the group consisting of silver, gold, zinc, tin, copper, platinum and palladium or a combination thereof.

99. The process of claim 85, wherein the reflective security feature comprises the metallic particles, and wherein the average distance between adjacent metallic particles in the reflective security feature is less than about 700 nm.

100. The process of claim 99, wherein a majority of the metallic particles in the reflective security feature are necked with at least one adjacent nanoparticle.

101. The process of claim 85, wherein step (b) comprises direct write printing the ink onto a substrate surface having an image to form the reflective security feature.

102. The process of claim 101, wherein the image is viewable through the reflective security feature when viewed at a first angle relative to the surface, and wherein at least a portion of the image is at least partially obscured when viewed from a second angle relative to the surface.

103. The process of claim 102, wherein the second angle is about 180° minus the angle of incident light, relative to the surface.

104. The process of claim 101, wherein the image is formed from a printing process selected from the group consisting of direct write printing, intaglio printing, gravure printing, lithographic printing and flexographic printing processes.

105. The process of claim 1101, wherein the image is selected from the group consisting of a hologram, a black and white image, a color image, a watermark, a UV fluorescent image, text and a serial number.

106. The process of claim 101, wherein the reflective security feature comprises a non-continuous reflective layer.

107. The process of claim 106, wherein the reflective security feature comprises a plurality of reflective microimages, wherein at least one microimage optionally comprises variable data.

108. The process of claim 101, wherein the reflective security feature comprises a continuous reflective layer.

109. The process of claim 108, wherein the continuous reflective layer is translucent.

110. The process of claim 108, wherein the continuous reflective layer is opaque.

111. The process of claim 108, wherein the image has a longitudinally varying topography.

112. The process of claim 111, wherein the continuous reflective layer presents a translation of the longitudinally varying topography of the overlapped image.

113. A direct write printing process for printing a security feature utilizing a direct write printer having a direct write head, the direct write head capable of generating and depositing droplets of an ink on a substrate, the ink comprising metallic particles, the process comprising the steps of operating the direct write head at greater than 5000 s⁻¹ such that each drop of ink generated comprises about 5 picoliters to about 100 picoliters of the ink, and wherein the substrate is moving at a rate of greater than 1 m/s.

114. The direct write printing process of claim 113, wherein the process further comprises the step of heating the ink and/or the direct write head.

115. The direct write printing process of claim 113, wherein the temperature of the ink or the direct write head is maintained at a temperature of from about 30° C. to about 100° C.

116. The direct write printing process of claim 113, wherein the operating occurs continuously at a substantially constant temperature.

117. The direct write printing process of claim 113, wherein the direct write head has one or more orifices having a diameter of not greater than about 100 μm.

118. The direct write printing process of claim 113, wherein the security feature has a size less than about 200 μm.

119. The direct write printing process of claim 113, wherein the security feature further comprises variable information.

120. The direct write printing process of claim 119, wherein the variable information comprises covert information and/or overt information.

121. The direct write printing process of claim 113, wherein the substrate comprises at least one image.

122. The direct write printing process of claim 121, wherein the security feature comprises a continuous reflective layer.

123. The direct write printing process of claim 122, wherein the continuous reflective layer is translucent.

124. The direct write printing process of claim 122, wherein the continuous reflective layer is opaque.

125. The direct write printing process of claim 122, wherein the image has a longitudinally varying topography.

126. The direct write printing process of claim 125, wherein the continuous reflective layer presents a translation of the longitudinally varying topography of the overlapped image.

127. The direct write printing process of claim 121, wherein the image is viewable through the security feature when viewed at a first angle relative to the surface, and wherein at least a portion of the image is at least partially obscured when viewed from a second angle relative to the surface.

128. The direct write printing process of claim 127, wherein the second angle is about 180° minus the angle of incident light, relative to the surface.

129. The direct write printing process of claim 121, wherein the image is formed from a printing process selected from the group consisting of direct write printing, intaglio printing, gravure printing, lithographic printing and flexographic printing processes.

130. The direct write printing process of claim 121, wherein the image is selected from the group consisting of a hologram, a black and white image, a color image, a watermark, a UV fluorescent image, text and a serial number.

131. The direct write printing process of claim 113, wherein the security feature is formed at a rate greater than about 15 m/s.

132. The direct write printing process of claim 113, wherein the process further comprises the step of applying ultraviolet or infrared radiation to the deposited droplets.

133. The direct write printing process of claim 113, wherein the ink comprises a non-UV-curable vehicle, and wherein the process further comprises the step of applying ultraviolet radiation to the deposited droplets.

134. The direct write printing process of claim 113, wherein the security feature is at least partially semitransparent.

135. The direct write printing process of claim 113, wherein the substrate comprises a sheet of transparent material and a reflective layer, the transparent material having a transparent surface, and the security feature being printed on the transparent surface.

136. The direct write printing process of claim 135, wherein the security feature exhibits an optical interference pattern.

137. The direct write printing process of claim 113, wherein the security feature comprises a non-continuous reflective layer.

138. The direct write printing process of claim 137, wherein the security feature comprises a plurality of reflective microimages, wherein at least one microimage optionally comprises variable data.

139. The direct write printing process of claim 113, wherein the metallic particles comprise a metal selected from the group consisting of silver, gold, zinc, tin, copper, platinum and palladium or a combination thereof.

140. The direct write printing process of claim 113, wherein the average distance between adjacent metallic particles in the reflective security feature is less than about 700 nm.

141. The direct write printing process of claim 140, wherein a majority of the metallic particles in the security feature are necked with at least one adjacent nanoparticle.

142. A process for forming reflective security features, the process comprising the steps of:
(a) providing an ink comprising metallic particles; and
(b) printing the ink onto a substrate to form the reflective security features at a rate greater than 1 m/s, based on the rate of the substrate.

143. The process of claim 142, wherein step (b) comprises direct write printing the ink to form the reflective security feature.

144. The process of claim 142, wherein step (b) comprises ink jet printing the ink to form the reflective security feature.

145. The process of claim 142, wherein step (b) comprises digitally printing the ink to form the reflective security feature.

146. The process of claim 142, wherein the rate is greater than about 5 m/s.

147. The process of claim 142, wherein the rate is greater than about 10 m/s.

148. The process of claim 142, wherein the rate is greater than about 15 m/s.

149. The process of claim 142, wherein the rate is greater than about 20 m/s.

150. The process of claim 142, wherein the security features have a resolution, at least in part, greater than about 200 dpi in the x and y directions.

151. The process of claim 142, wherein the security features have a resolution, at least in part, greater than about 300 dpi in the x and y directions.

152. The process of claim 142, wherein the security features have a resolution, at least in part, greater than about 400 dpi in the x and y directions.

153. A security feature comprising metallic particles and exhibiting a conductivity authentication feature.

154. The security feature of claim 153, wherein the security feature is reflective.

155. The security feature of claim 153, wherein the metallic particles comprise a bulk metal and wherein at least a portion of the security feature has a resistivity not higher than about 30 times the resistivity of the bulk metal.

156. The security feature of claim 153, wherein the metallic particles comprise a bulk metal and wherein at least a portion of the security feature has a resistivity not higher than about 20 times the resistivity of the bulk metal.

157. The security feature of claim 153, wherein the security feature or a portion thereof further includes a magnetic property.

158. The security feature of claim 153, wherein the security feature is substantially non-conductive but comprises a conductive portion.

159. The security feature of claim 158, wherein the metallic particles comprise a bulk metal and wherein the conductive portion has a resistivity that is less than about 30 times the resistivity of the bulk metal.

160. The security feature of claim 158, wherein the metallic particles comprise a bulk metal and wherein the conductive portion has a resistivity that is less than about 20 times the resistivity of the bulk metal.

161. The security feature of claim 158, wherein the metallic particles comprise a bulk metal and wherein the security feature has a resistivity that is at least 30 times the resistivity of the bulk metal.

162. The security feature of claim 158, wherein the metallic particles comprise a bulk metal and wherein the security feature has a resistivity that is at least 50 times the resistivity of the bulk metal.

163. A UV curable security feature comprising metallic particles and free of a UV curable organic composition.

164. The UV curable security feature of claim 163, wherein the metallic particles have an average particle size of less than about 5 μm.

165. The UV curable security feature of claim 163, wherein the UV curable security feature comprises metallic nanoparticles.

166. The UV curable security feature of claim 163, wherein the metallic particles have an average particle size of less than about 1 μm.

167. The UV curable security feature of claim 163, wherein the UV curable organic composition is a UV curable vehicle.

168. The UV curable security feature of claim 163, wherein the UV curable organic composition is a UV curable monomer or polymer.

169. The UV curable security feature of claim 163, wherein the UV curable security feature is curable to form a sintered network of the metallic nanoparticles.

170. A substantially non-conductive UV curable security feature comprising conductive portions or components, wherein the security feature is free of a UV curable composition.

171. The substantially non-conductive UV curable security feature of claim 170, wherein the security feature is reflective.

172. The substantially non-conductive UV curable security feature of claim 170, wherein the security feature includes a magnetic property.

173. The substantially non-conductive UV curable security feature of claim 170, wherein the substantially non-conductive UV curable security feature comprises metallic particles, the metallic particles comprising a bulk metal, wherein the conductive portions or components have a resistivity not higher than about 30 times the resistivity of the bulk metal.

174. The substantially non-conductive UV curable security feature of claim 173, wherein the portions or components have a resistivity not higher than about 20 times the resistivity of the bulk metal.

175. The substantially non-conductive UV curable security feature of claim 173, wherein the substantially non-conductive UV curable security feature has a resistivity that is at least 50 times the resistivity of the bulk metal.

176. The substantially non-conductive UV curable security feature of claim 170, wherein the security feature comprises metallic particles having an average particle size of less than about 5 μm.

177. The substantially non-conductive UV curable security feature of claim 170, wherein the security feature comprises metallic particles having an average particle size of less than about 1 μm.

178. A substantially non-conductive UV curable security feature of claim 170, wherein the UV curable composition is a UV curable vehicle.

179. A substantially non-conductive UV curable security feature of claim 170, wherein the UV curable composition is a UV curable monomer or polymer.

180. A security feature, comprising:
(a) a first layer comprising first metallic particles, the first metallic particles comprising a first metal oxide; and
(b) a second layer disposed at least in part on the first layer, the second layer comprising second metallic particles comprising a second metal oxide.

181. The security feature of claim 180, further comprising:
(c) a third layer disposed at least in part on the second layer, the third layer comprising third metallic particles comprising the first metal oxide.

182. The security feature of claim 181, wherein the first metal oxide is selected from the group consisting of silica, titania and mica, wherein the second metal oxide is selected from the group consisting of silica, titania and mica, and wherein the first metal oxide is different from the second metal oxide.

183. The security feature of claim 181, wherein the first metal oxide comprises titania and the second metal oxide comprises mica.

184. The security feature of claim 181, wherein the security feature exhibits a color shift as it is tilted.
